(19) United States
(12) Patent Application Publication
(10) Pub. No.: US 2026/0246985 A1
(43) Pub. Date: Aug. 20, 2026

(54) Generation of Reformatted Content

(71) Applicant: Google LLC, Mountain View, CA (US)

(72) Inventors: Jonathan Brunsman, Boulder, CO (US); Yi Yang, Woodside, CA (US); Patrick Lacz, Louisville, CO (US); Clovis Rigout, Brooklyn, NY (US); Sarah Hobbs, Seattle, WA (US); Christian Sonntag, San Francisco, CA (US)

(21) Appl. No.: 19/406,631

(22) Filed: Dec. 2, 2025

Related U.S. Application Data
(60) Provisional application No. 63/726,821, filed on Dec. 2, 2024.

(51) Int. Cl. H04N 21/2343

(52) U.S. Cl. CPC H04N 21/2343

(57) ABSTRACT

Methods, systems, devices, and non-transitory computer readable media for generating reformatted content are provided. The disclosed technology can include obtaining content data comprising content segments associated with audio-video content. Based on inputting the content data into machine-learned classification models, classes associated with the content segments can be determined. Based on inputting the content segments into content-specific machine-learned models, reformatted content data comprising reformatted content segments associated with text content or image content that is based on the features of the content segments can be generated. Each content segment can be inputted into a content-specific machine-learned model that is configured to generate a reformatted content segment based on the classes associated with the content segment. Query data comprising queries can be obtained and a reformatted content segment associated with the queries can be determined. Furthermore, reformatted content based on the reformatted content segment can be generated.

### PRIORITY CLAIM

The present application claims the benefit of United States Provisional Application 63/726,821, filed December 2, 2024. United States Provisional Application 63/726,821 is incorporated herein by reference in its entirety.

### FIELD

The present disclosure relates generally to generating reformatted content based on audio-video content. More particularly, the present disclosure relates to using machine-learned models to process audio-video content and generate reformatted content that includes newly generated text and images based on the audio-video content.

### BACKGROUND

Various types of content can be accessed via the Internet, including content that is accessed via a search. For certain types of content (e.g., product reviews) some users may prefer consuming text or still image content over video content. This preference may be attributed to a variety of factors including the speed with which a user can consume text and/or still images in comparison to video content. In contrast with static text or images that can be consumed at a rate determined by the user, the rate at which audio-video content is consumed tends to be determined by the playback speed of the video content. Accordingly, there may be different approaches to processing content.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating reformatted content. The computer-implemented method can comprise obtaining, by a computing system comprising one or more processors, content data comprising a plurality of content segments associated with audio-video content. The computer-implemented method can comprise determining, by the computing system, based on inputting the content data into one or more machine-learned classification models, one or more classes associated with the plurality of content segments. The one or more machine-learned classification models can be configured to determine the one or more classes based on one or more features of the plurality of content segments. The computer-implemented method can comprise generating, by the computing system, based on inputting the plurality of content segments into one or more class-based machine-learned models, reformatted content data comprising a plurality of reformatted content segments associated with text content or image content that is based on the one or more features of the plurality of content segments. Each of the one or more class-based machine-learned models can be configured to reformat the one or more features of the plurality of content segments associated with one class of the one or more classes. Each content segment of the plurality of content segments can be inputted into the class-based machine-learned model that is associated with the one or more classes of the content segment. The computer-implemented method can comprise obtaining, by the computing system, query data comprising one or more queries. The computer-implemented method can comprise determining, by the computing system, one or more reformatted content segments that are associated with the one or more queries. The computer-implemented method can comprise generating, by the computing system, reformatted content based on the one or more reformatted content segments associated with the one or more queries.

Another example aspect of the present disclosure is directed to one or more tangible non-transitory computer-readable media storing computer-readable instructions that when executed by one or more processors cause the one or more processors to perform operations. The operations can comprise obtaining content data comprising a plurality of content segments associated with audio-video content. The operations can comprise determining, based on inputting the content data into one or more machine-learned classification models, one or more classes associated with the plurality of content segments. The one or more machine-learned classification models can be configured to determine the one or more classes based on one or more features of the plurality of content segments. The operations can comprise generating, based on inputting the plurality of content segments into one or more class-based machine-learned models, reformatted content data comprising a plurality of reformatted content segments associated with text content or image content that is based on the one or more features of the plurality of content segments. Each of the one or more class-based machine-learned models can be configured to reformat the one or more features of the plurality of content segments associated with one class of the one or more classes. Each content segment of the plurality of content segments can be inputted into the class-based machine-learned model that is associated with the one or more classes of the content segment. The operations can comprise obtaining query data comprising one or more queries. The operations can comprise determining one or more reformatted content segments that are associated with the one or more queries. The operations can comprise generating reformatted content based on the one or more reformatted content segments associated with the one or more queries.

Another example aspect of the present disclosure is directed to a computing system comprising: one or more processors; one or more non-transitory computer-readable media storing instructions that when executed by the one or more processors cause the one or more processors to perform operations. The operations can comprise obtaining content data comprising a plurality of content segments associated with audio-video content. The operations can comprise determining, based on inputting the content data into one or more machine-learned classification models, one or more classes associated with the plurality of content segments. The one or more machine-learned classification models can be configured to determine the one or more classes based on one or more features of the plurality of content segments. The operations can comprise generating, based on inputting the plurality of content segments into one or more class-based machine-learned models, reformatted content data comprising a plurality of reformatted content segments associated with text content or image content that is based on the one or more features of the plurality of content segments. Each of the one or more class-based machine-learned models can be configured to reformat the one or more features of the plurality of content segments associated with one class of the one or more classes. Each content segment of the plurality of content segments can be inputted into the class-based machine-learned model that is associated with the one or more classes of the content segment. The operations can comprise obtaining query data comprising one or more queries. The operations can comprise determining one or more reformatted content segments that are associated with the one or more queries. The operations can comprise generating reformatted content based on the one or more reformatted content segments associated with the one or more queries.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system that can generate reformatted content according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of generating reformatted content according to example embodiments of the present disclosure;

FIG. 5 depicts an example of generating feature-based reformatted content according to example embodiments of the present disclosure;

FIG. 6 depicts an example of generating ranking-based reformatted content according to example embodiments of the present disclosure;

FIG. 7 depicts an example of generating evaluation-based reformatted content according to example embodiments of the present disclosure;

FIG. 8 depicts an example of generating instruction-based reformatted content according to example embodiments of the present disclosure;

FIG. 9 depicts an example of generating dialogue-based reformatted content according to example embodiments of the present disclosure;

FIG. 10 depicts an example of generating translated reformatted content according to example embodiments of the present disclosure;

FIG. 11 depicts an example of generating age-based reformatted content according to example embodiments of the present disclosure;

FIG. 12 depicts an example of generating discovery feed reformatted content according to example embodiments of the present disclosure;

FIG. 13 depicts a flow chart diagram of an example method of generating reformatted content according to example embodiments of the present disclosure;

FIG. 14 depicts a flow chart diagram of an example method of determining reformatted content associated with queries according to example embodiments of the present disclosure;

FIG. 15 depicts a flow chart diagram of an example method of generating reformatted content according to example embodiments of the present disclosure.

FIG. 16 is a flow chart diagram illustrating an example method for training a machine-learned model according to example implementations of aspects of the present disclosure;

FIG. 17 is a block diagram of an example processing flow for using machine-learned model(s) to process input(s) to generate output(s) according to example implementations of aspects of the present disclosure;

FIG. 18 is a block diagram of an example sequence processing model according to example implementations of aspects of the present disclosure;

FIG. 19 is a block diagram of an example technique for populating an example input sequence for processing by a sequence processing model according to example implementations of aspects of the present disclosure;

FIG. 20 is a block diagram of an example model development platform according to example implementations of aspects of the present disclosure;

FIG. 21 is a block diagram of an example training workflow for training a machine-learned model according to example implementations of aspects of the present disclosure;

FIG. 22 is a block diagram of an inference system for operating one or more machine-learned model(s) to perform inference according to example implementations of aspects of the present disclosure;

FIG. 23 is a block diagram of an example networked computing system according to example implementations of aspects of the present disclosure;

FIG. 24 is a block diagram of an example computing device according to example implementations of aspects of the present disclosure; and

FIG. 25 is a block diagram of an example computing device according to example implementations of aspects of the present disclosure.

Reference numerals that are repeated across plural figures are intended to identify the same features in various implementations.

### DETAILED DESCRIPTION

In general, the present disclosure is directed to generating reformatted content based on the detection, recognition, classification, and/or parsing of features (e.g., visual features, audio features, and/or textual features) in content that can include audio-video content (e.g., streaming video that includes audio). The disclosed technology can process and transform source content (e.g., content data) such as audio-video content and generate reformatted content (e.g., reformatted content data) based on the source content. The reformatted content can include a new combination of generated content including text and/or images based at least in part on audio-video content. For example, source content comprising a streaming video review of a restaurant can be used to generate reformatted content that includes a text-based key takeaway of whether the restaurant is good, features of the restaurant including the ambiance and quality of service, a deeper analysis of the review in which the key takeaways are further discussed, and images of the restaurant that can be retrieved from the source content or an external source (e.g., an image repository that includes images of the restaurant). Further, the appearance of the reformatted content can be tailored to the content such that a restaurant review can have a different design (e.g., color scheme, typography, and/or layout) from a how-to guide.

In some embodiments, the reformatted content can be generated based in part on a query (e.g., one or more current search queries and/or one or more historical search queries) associated with the source content. Additionally, the disclosed technology can implement machine-learned models (e.g., generative machine-learned models that can comprise transformer models and/or diffusion models) that have been configured and/or trained to generate reformatted content based on the detection, recognition, classification, and/or parsing of features in content that can include audio-video content. Further, the disclosed technology can generate information that can be used to index and/or retrieve reformatted content segments associated with the reformatted content.

The disclosed technology can include a computing system that can obtain content data which can comprise a plurality of content segments associated with audio-video content. For example, the plurality of content segments can comprise audio-video content from a streaming video website. Further, the audio-video content can be based on one or more portions of audio-video content (e.g., a single video clip comprising audio-video content or a plurality of video clips comprising audio-video content). The computing system can then determine one or more classes associated with the plurality of content segments. For example, the computing system can determine that a list of the top ten movies of the year can be associated with a media review class (e.g., reviews of books, television programs, and/or movies) and/or a ranking class (e.g., a class associated with ranking content segments).

Further, one or more classes associated with the plurality of content segments can be determined based on inputting the plurality of content segments into one or more machine-learned models (e.g., one or more machine-learned classification models), that are configured and/or trained to determine the one or more classes based on features of the plurality of content segments (e.g., visual features, audio features, and/or text features that can be based on transcription information such as closed captioning data associated with audio-video content). For example, the one or more machine-learned models can be configured and/or trained to detect, recognize, classify, and/or parse audio features (e.g., recognized speech in audio) and/or visual features (e.g., recognized faces, places, and/or objects in video) in the plurality of content segments and determine the one or more classes associated with the plurality of content segments.

The computing system can then generate reformatted content data that can comprise a plurality of reformatted content segments associated with text content and/or image content that is based on the one or more features of the plurality of content segments. Further, the reformatted content data can be based on inputting the plurality of content segments into one or more machine-learned models (e.g., one or more class-based machine-learned models), that are configured and/or trained to reformat the one or more features of the plurality of content segments associated with one class of the one or more classes. Each content segment of the plurality of content segments can be inputted into the class-based machine-learned model that is associated with the one or more classes of the content segment. For example, the content segments associated with a media review class can be inputted into a machine-learned model that is configured and/or trained to generate reformatted content data associated with a movie review (e.g., a style of reformatted content associated with a movie review). In some embodiments, one or more machine-learned models can be configured and/or trained to receive the content data, determine the one or more classes of the content data, and generate the reformatted content data (e.g., a single machine-learned model that is configured and/or trained to receive content data, classify the content data, and generate the reformatted content data).

The computing system can then obtain queries (e.g., search queries) and based on the queries, determine the reformatted content segments that are associated with the queries. For example, a query for a review of an amusement park can result in the retrieval of reformatted content segments associated with reviews of various amusement parks. The disclosed technology can then generate reformatted content based on the reformatted content segments that were retrieved. For example, in response to a query for a review of an amusement park, the computing system can retrieve a reformatted content segment that is based on a thirty-minute video from a streaming video service and comprises a text-based review of the amusement park. The reformatted content associated with the reformatted content segment can comprise a brief summary of the reviewer’s experience at an amusement park, structured content including a bulleted list of the pros and cons of the amusement park, the pros (e.g., fun rides and a relaxing atmosphere) and cons (e.g., long queues) of the amusement park, still images of the amusement park which can include images captured by the reviewer and/or images retrieved from external sources (e.g., official images of the amusement park retrieved from an image repository associated with the amusement park), a more detailed review of the advantages and disadvantages of the amusement park, and a final summary that briefly summarizes the review and can include a rating (e.g., a rating from one to ten, a letter grade, and/or a thumbs up or thumbs down rating).

The reformatted content can be used in a variety of applications including search applications. Further, the reformatted content data can be more rapidly consumed and reduce the amount of time spent searching for relevant content. As such, the disclosed technology allows for more concise content that can be used in a variety of applications including search applications, social media applications, and/or various other types of applications.

Accordingly, the disclosed technology can automatically generate reformatted content that transforms content from one type of content (e.g., audio-video) into a different type of content (e.g., text and images) that can be more easily consumed. Further, the disclosed technology can assist a user in more effectively performing the technical task of content generation by means of a continued and/or guided human-machine interaction process in which a user may provide queries that are used to access content that is processed and transformed by the computing systems and from which the disclosed technology generates real-time reformatted content. For example, a user can use a smartphone to access content from a website and send a link to the content a remote machine-learned model system that implements machine-learned models that generate reformatted content based on the content, then sends the reformatted content back to the user’s smartphone.

The disclosed technology can be implemented in a computing system (e.g., a reformatted content generation computing system) that is configured to access data and/or perform operations on the data. For example, the operations performed by the computing system can comprise obtaining content data; determining, based on inputting the content data into one or more machine-learned classification models, one or more classes associated with the plurality of content segments; generating, based on inputting the plurality of content segments into one or more class-based machine-learned models, reformatted content data comprising a plurality of reformatted content segments; obtaining query data comprising one or more queries; determining one or more reformatted content segments associated with the one or more queries; and generating reformatted content based on the one or more reformatted content segments associated with the one or more queries. Further, the computing system can leverage one or more machine-learned models that have been configured and/or trained to process (e.g., detect, classify, recognize, and/or parse) input comprising content data and generate classifications of the content data and/or reformatted content segments comprising a plurality of reformatted content segments based on processing the input.

The computing system can be included as part of a system that includes a server computing device that receives data (e.g., content data) from a user’s client computing device, performs operations based on the data, and sends output comprising reformatted content data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with obtaining content data; determining, based on inputting the content data into one or more machine-learned classification models, one or more classes associated with the plurality of content segments; generating, based on inputting the plurality of content segments into one or more class-based machine-learned models, reformatted content data comprising a plurality of reformatted content segments; obtaining query data comprising one or more queries; determining one or more reformatted content segments associated with the one or more queries; and generating reformatted content based on the one or more reformatted content segments associated with the one or more queries.

The computing system can obtain, access, receive, and/or retrieve content data. The content data can comprise a plurality of content segments associated with audio-video content, a plurality of content segments associated with video content, a plurality of content segments associated with audio content, a plurality of content segments associated with image content (e.g., images), and/or a plurality of content segments associated with text content. For example, the content data can comprise a plurality of content segments from an audio-video repository that can comprise a plurality of content segments (e.g., videos with accompanying audio) associated with a video streaming service that can provide a content segment (e.g., a single video) based on queries to the audio-video repository. Further, the audio-video content can be based on one or more portions of audio-video content. In some embodiments, the audio-video content can comprise one video clip (e.g., one video clip from a source of audio-video content which can include a video streaming service). In some embodiments, the audio-video content can comprise a plurality of video clips (e.g., video clips from a source of audio-video content which can include a video streaming service).

The computing system can determine one or more classes associated with the content data and/or plurality of content segments. Further, the computing system can determine the one or more classes based on inputting the content data into one or more machine-learned classification models, one or more classes associated with the plurality of content segments. The one or more machine-learned classification models can be configured and/or trained to determine the one or more classes based on one or more features of the plurality of content segments. The one or more classes can be associated with one or more topics of the plurality of content segments including animals (e.g., domestic animals and/or wild animals), sports, politics, news (e.g., breaking news), professional development, jobs, vehicles (e.g., automobiles, boats, and/or airplanes), entertainment (e.g., literature, movies, and/or television programs), family life, the law, science, mathematics, philosophy, technology, education, and/or geography (e.g., information associated with a city or nation).

Further, the one or more classes can be based on subject matter that is discussed within the plurality of content segments. For example, the one or more machine-learned classification models can be configured and/or trained to recognize speech within a content segment and determine the subject matter discussed in the content segment. The subject matter can be associated with any of the one or more topics. Further, the one or more classes can be associated with a type of reformatted content that is generated. Based on the one or more classes comprising the one or more topics and/or the subject matter of a content segment, the one or more class-based machine-learned models can generate reformatted content data that can comprise a specific type of reformatted content segment that is based on the one or more classes of the content segment.

In some embodiments, the one or more machine-learned classification models can be configured and/or trained to recognize a spoken language, a written language, and/or one or more objects in the audio-video content. The one or more classes can be based on recognition of the one or more objects, the spoken language, and/or the written language in the audio-video content. For example, the one or more machine-learned classification models can be configured and/or trained to detect and/or recognize one or more languages that are spoken in a content segment.

The computing system can generate reformatted content data. The reformatted content data can comprise a plurality of reformatted content segments. The plurality of reformatted content segments can be associated with content that can include text content and/or image content. In some embodiments, the plurality of reformatted content segments can comprise audio-video content, video content, and/or audio content. The text content and/or the image content can be based on one or more features of the plurality of content segments. Further, the reformatted content data can comprise a plurality of reformatted content segments associated with audio content, a plurality of reformatted content segments associated with image content, a plurality of reformatted content segments associated with video content, and/or a plurality of reformatted content segments associated with audio-video content.

Further, the computing system can generate the reformatted content data based on inputting the plurality of content segments into one or more class-based machine-learned models. Each of the one or more class-based machine-learned models can be configured and/or trained to reformat (e.g., modify and/or transform) the one or more features of the plurality of content segments associated with one or more classes of the one or more classes. For example, each of the one or more class-based machine-learned models can be configured and/or trained to reformat the one or more features of the plurality of content segments associated with one class of the one or more classes. Further, each content segment of the plurality of content segments can be inputted into the class-based machine-learned model that is associated with the one or more classes of the content segment. For example, if a content segment is associated with one or more classes comprising place class comprising a restaurant, a geographical class comprising the city of Chicago, a language class comprising the English language, and subject matter class comprising a review class, the content segment can be inputted into a class-based machine-learned model that is associated with those classes. The one or more class-based machine-learned models can then generate reformatted content data comprising a reformatted content segment that comprises English language text and images from a combination of the source content and external sources that are associated with a review of a restaurant in the city of Chicago.

The plurality of reformatted content segments can comprise content information associated with indexing and/or retrieving the plurality of content segments. The content information can comprise one or more indications of the one or more classes associated with the plurality of content segments, one or more identifiers of the plurality of content segments, and/or one or more web resources associated with the plurality of content segments. In some embodiments, the information associated with indexing and/or retrieving the plurality of content segments can comprise a plurality of hash values that can facilitate retrieval of the plurality of reformatted content segments and/or the corresponding plurality of content segments.

The one or more class-based machine-learned models can comprise one or more multimodal transformer models that are trained to generate the reformatted content data based on training data. The training data can comprise training content data and/or corresponding ground-truth reformatted training content data. Further, the training data can comprise a plurality of training queries. The training content data can comprise a plurality of training audio-video segments (e.g., audio-video content segments comprising reviews and how-to guides), a plurality of training video segments, a plurality of training images (e.g., images associated with reviews and how-to guides), a plurality of training text segments (e.g., text descriptions of reviews and how-to guides), and/or a plurality of training audio segments.

In some embodiments, the one or more class-based machine-learned models can be configured and/or trained to determine one or more transformations of the one or more features of the plurality of content segments. The one or more class-based machine-learned models can be configured and/or trained to generate the plurality of reformatted content segments based on the transformations of the one or more features of the plurality of content segments. The one or more transformations of the one or more features of the plurality of content segments can comprise changing the size, shape, relative dimensions, color, and/or brightness of visual features; changing the tone, language, and/or reading level of text features; and/or changing the pitch, volume, and/or playback speed of audio features.

In some embodiments, the one or more class-based machine-learned models can comprise a class-based machine-learned model that is configured and/or trained to generate the reformatted content data based on one or more content segments of the plurality of content segments that are unclassified or one or more content segments of the plurality of content segments that are classified as being in a generic class. For example, if the one or more class-based machine-learned models determine that a content segment is not associated with any other class, the one or more class-based machine-learned models can determine that the content segment is part of a generic class or a default class. The generic class can be associated with a particular layout, color scheme, typography, and/or other visual characteristics that may be applied to content segments that are associated with the generic class.

In some embodiments, the one or more class-based machine-learned models can be configured and/or trained to modify, based on the one or more classes associated with the plurality of content segments, a spatial arrangement of the text content and/or image content associated with the plurality of reformatted content segments. The one or more class-based machine-learned models can be configured and/or trained to modify, based on the one or more classes associated with the plurality of content segments, a color scheme and/or typography (e.g., font style and/or font size) associated with the plurality of reformatted content segments.

In some embodiments, the one or more class-based machine-learned models can be configured and/or trained to determine, based on performing one or more natural language processing operations on the plurality of content segments, one or more portions of the plurality of content segments that are associated with one or more features of a product and/or service. The one or more class-based machine-learned models can be configured and/or trained to generate the plurality of reformatted content segments based on the one or more features of the product or service.

In some embodiments, the one or more class-based machine-learned models can be configured and/or trained to determine, based on performing one or more natural language processing operations on the plurality of content segments, one or more portions of the plurality of content segments that are associated with one or more advantages and/or disadvantages of an object, a place, and/or an event. The one or more class-based machine-learned models are further configured and/or trained to generate the plurality of reformatted content segments based on the one or more advantages and/or disadvantages of the object (e.g., a vehicle, a piece of sporting equipment, and/or a work of art), the place (e.g., a restaurant, amusement park, and/or national park), and/or the event (e.g., a sporting event, conference, and/or concert).

In some embodiments, the one or more class-based machine-learned models can be configured and/or trained to determine, based on performing one or more natural language processing operations on the plurality of content segments, one or more portions of the plurality of content segments that are associated with rankings of products, rankings of services, and/or rankings of places. The one or more class-based machine-learned models can be configured and/or trained to generate the plurality of reformatted content segments based on the rankings of products, the rankings of services, and/or the rankings of places.

In some embodiments, the one or more class-based machine-learned models can be configured and/or trained to determine, based on performing one or more natural language processing operations on the plurality of content segments, one or more portions of the plurality of content segments that are associated with one or more instructions. The one or more class-based machine-learned models can be configured and/or trained to generate the plurality of reformatted content segments based on the one or more portions of the plurality of content segments that are associated with the one or more instructions. The one or more instructions can comprise one or more assembly instructions (e.g., furniture assembly instructions), one or more instructions to perform a task, and/or one or more recipes. The one or more instructions can comprise instructions for simple tasks (e.g., building a simple chair) that can be performed in a short period of time (e.g., less than an hour) and/or more complex tasks (e.g., applying to a university) that may take a longer amount of time (e.g., days or weeks) to prepare for and/or complete.

In some embodiments, the one or more class-based machine-learned models can be configured and/or trained to determine, based on performing one or more natural language processing operations on the plurality of content segments, one or more portions of the plurality of content segments that are associated with dialogue. The one or more class-based machine-learned models can be configured and/or trained to recognize different speakers associated with the dialogue. The one or more class-based machine-learned models are further configured and/or trained to generate the plurality of reformatted content segments based on the dialogue and recognition of the different speakers associated with the dialogue. For example, if two individuals are debating, the one or more class-based machine-learned models can be configured and/or trained to identify each of the speakers either by name or using a generic identifier (e.g., SPEAKER 1 and SPEAKER 2).

In some embodiments, the one or more class-based machine-learned models can be configured and/or trained to determine a plurality of titles and/or a plurality of summaries associated with the plurality of content segments. The one or more class-based machine-learned models can be configured and/or trained to generate the plurality of reformatted content segments based on the plurality of titles and/or the plurality of summaries.

In some embodiments, the one or more class-based machine-learned models can be configured and/or trained to generate a plurality of reformatted content segments that can comprise one or more interactive elements associated with the plurality of content segments. The one or more interactive elements can comprise one or more interactive links (e.g., links that can lead a user to a website based on clicking the link) to one or more web resources (e.g., web pages of websites) associated with the plurality of content segments.

The computing system can obtain, access, receive, and/or retrieve query data. The query data can comprise one or more queries. Further, the one or more queries can comprise one or more search queries. For example, the computing system can obtain one or more queries comprising search queries for content that can comprise audio-video content. The one or more queries can be directed to a computing system that implements a search engine that can be used to determine the plurality of reformatted content segments associated with the one or more queries.

The query data can comprise one or more queries based on one or more current search queries and/or one or more queries based on one or more historical search queries. For example, the one or more current search queries can comprise a search query that was entered into a search engine and can be used to generate one or more reformatted content segments based on the one or more current search queries.

The one or more historical search queries can comprise one or more search queries from previous searches (e.g., search queries from the previous day and/or from the previous months). For example, the one or more historical search queries can comprise one or more historical search queries that were entered into a search engine over the preceding month and can be used to generate one or more reformatted content segments based on the one or more historical search queries. In some embodiments, the one or more historical search queries can comprise search queries from a historical time period (e.g., one or more search queries from the past month or one or more search queries from the past year).

The computing system can determine one or more reformatted content segments that are associated with the one or more queries. For example, the computing system can perform a search in which search results associated with the one or more reformatted content segments that match and/or are similar (e.g., within a similarity threshold) to the one or more queries are generated and/or determined.

In some embodiments, one or more machine-learned models (e.g., one or more machine-learned reformatted content embedding generation models) can be configured and/or trained to receive the content data and generate a plurality of reformatted content segments that comprise a corresponding plurality of reformatted content embeddings. In some embodiments, the one or more class-based machine-learned models can be configured and/or trained to generate a plurality of reformatted content segments that comprise and/or be associated with a corresponding plurality of reformatted content embeddings.

Determining the one or more reformatted content segments that are associated with the one or more queries can comprise generating a query embedding based on the query data. For example, one or more machine-learned models (e.g., one or more reformatted content embedding generation models or the one or more class-based machine-learned models) can be configured and/or trained to generate a query embedding based on input comprising the query data. Further, determining the one or more reformatted content segments can comprise determining, based on comparing the query embedding to the plurality of reformatted content embeddings, the one or more reformatted content segments that are associated with the one or more queries.

The computing system can generate reformatted content based on the one or more reformatted content segments associated with the one or more queries. The computing system can retrieve the one or more reformatted content segments that are associated with the one or more queries. For example, if the one or more queries are associated with a search for reviews of a particular product (e.g., an automobile), the computing system can retrieve the one or more reformatted content segments that are associated with the one or more queries for an automobile. Further, the computing system can perform one or more operations to modify the one or more reformatted content segments. The computing system can adjust the size and/or shape of the reformatted content (e.g., text content, image content, video content) associated with the one or more reformatted content segments. Further, the pitch and/or volume of reformatted content comprising audio content can be modified. In some embodiments, the computing system can retrieve content (e.g., text content, image content, video content, and/or audio content) associated with one or more queries from an external source.

Generating reformatted content (e.g., generating reformatted content based on the one or more reformatted content segments that are associated with the one or more queries) can comprise determining one or more portions of the one or more reformatted content segments that satisfy one or more relevance criteria associated with a relevance of the one or more portions of the one or more reformatted content segments with respect to the one or more queries. Further, generating reformatted content can comprise generating one or more indications that emphasize the one or more portions of the one or more reformatted content segments that satisfy the one or more relevance criteria. The one or more relevance criteria can comprise one or more classes associated with the one or more queries matching or being similar to one or more classes associated with the one or more reformatted content segments. For example, a query associated with a request for a book review can be associated with a review class and a literature class. To satisfy the one or more relevance criteria, the one or more reformatted content segments may have to be associated with either a book class or a literature class.

Generating reformatted content (e.g., generating reformatted content based on the one or more reformatted content segments that are associated with the one or more queries) can comprise determining whether a content language associated with one or more portions of the one or more reformatted content segments matches a query language associated with the one or more queries. Further, generating reformatted content can comprise generating a translation of the content language into the query language in the one or more portions of the one or more reformatted content segments in which the content language does not match the query language.

The computing system can generate output based on the reformatted content. Further, the output based on the reformatted content can be outputted via a display component (e.g., a display device), an audio output device (e.g., loudspeakers), a projector (e.g., a laser projector), an extended reality (XR) device, an augmented reality (AR) device, or a virtual reality (VR) device.

In some embodiments, the computing system can generate visual output (e.g., one or more images, one or more audio-video segments, and/or one or more text segments) based on the reformatted content. Further, the computing system can generate visual output that can be displayed on a display component of a device that is configured to output the reformatted content. For example, the computing system can generate visual reformatted content comprising a deep dive analysis and/or key takeaways of a product (e.g., running shoes and/or a tennis racket) on a display component of a mobile computing device (e.g., a smartphone, a laptop computing device, and/or a tablet computing device).

The computing system can generate audio output (e.g., one or more audio segments) based on the reformatted content. Further, the computing system can generate audio output that can be outputted on an audio output component (e.g., audio speakers) of a device that is configured to output the reformatted content. For example, the computing system can generate audio reformatted content comprising key features of a book review via an audio output component of a mobile computing device (e.g., a smartphone, a smartwatch, and/or a tablet computing device).

In some embodiments, the output can be provided via an interface (e.g., a graphical user interface) that can be outputted via an output device (e.g., a display component). For example, the computing system can generate output comprising reformatted content that is displayed in a search results section of an interface. By way of further example, the computing system can generate output comprising reformatted content that is displayed in a discovery feed section of an interface.

One or more machine-learned models that can comprise the one or more machine-learned classification models and/or the one or more class-based machine-learned models can be trained using training data. Further, as part of training the one or more machine-learned models, the computing system can receive training data. The training data can comprise training content data. The training content data can comprise a plurality of training content segments and corresponding ground-truth reformatted content data comprising a plurality of ground-truth reformatted content segments. In some embodiments, the training data can comprise a plurality of training queries. Further, the training content data can comprise a plurality of training audio-video segments, a plurality of training video segments, a plurality of training images, a plurality of training text segments, and/or a plurality of training audio segments.

In some embodiments, the training data can comprise a plurality of embeddings. The plurality of embeddings can comprise a lower-dimensionality vector space representation of the training data. For example, the plurality of training video segments can be represented in a lower-dimensional vector space that can preserve information about the plurality of video segments in a lower-dimensionality vector space than the higher-dimensionality vector space of the original plurality of training video segments (e.g., a high-dimensional vector space that can include information about every frame of the training video segments). The plurality of embeddings can be arranged such that semantically similar embeddings are closer together in the vector space.

Training the one or more machine-learned models can comprise generating and/or determining, based on inputting the training data into the one or more machine-learned models, reformatted content data comprising a plurality of predicted reformatted content segments. Based on the received input which can comprise the training content data comprising a plurality of training content segments, the one or more machine-learned models can perform one or more operations and generate an output comprising a plurality of predicted reformatted content segments associated with the corresponding plurality of training content segments. The output of the one or more machine-learned models can then be evaluated based on one or more comparisons of the plurality of predicted reformatted content segments to a corresponding plurality of ground-truth reformatted content segments associated with the training data (e.g., a ground-truth reformatted segment based on the same training content segment as the predicted reformatted content segment).

Training the one or more machine-learned models can comprise determining a loss based on one or more differences between the plurality of predicted reformatted content segments and the plurality of ground-truth reformatted content segments. A loss function can be used to determine the loss. Further, the loss function can be used to evaluate one or more differences between the plurality of predicted reformatted content segments and the plurality of ground-truth reformatted content segments. The loss can increase in proportion to the number of the one or more differences between the plurality of predicted reformatted content segments and the plurality of ground-truth reformatted content segments. For example, if a plurality of predicted reformatted content segments and the corresponding plurality of ground-truth reformatted content segments comprise very different text content, very different image content, a significantly greater amount of text, a significantly greater number of images, and/or a very different arrangement of the reformatted content, the loss can be greater than if the predicted reformatted content segments and the corresponding plurality of ground-truth reformatted content segments have very similar text content (e.g., within a predetermined similarity threshold), very similar image content, a very similar amount of text, a very similar number of images, and/or a very similar arrangement of the reformatted content.

Training the one or more machine-learned models can comprise modifying a plurality of parameters of the one or more machine-learned models to minimize the loss. The plurality of parameters can be associated with detection, recognition, and/or classification of one or more features of the training data that can be used to generate and/or determine the plurality of predicted reformatted content segments. For example, the plurality of parameters can be associated with detection of visual features of video and/or images, recognition of text and/or audio, and/or classification of content. Further, the plurality of parameters can be associated with a plurality of weights that can be associated with an extent to which the plurality of parameters contributes to determining the loss.

Training the one or more machine-learned models can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameters can be associated with the plurality of predicted reformatted content segments such that parameters that are more heavily weighted can contribute more to determining the predicted reformatted content segments than parameters that are less heavily weighted. Over the plurality of iterations, the weights of the plurality of parameters can be modified to minimize the loss until a threshold loss that corresponds to a high accuracy of the one or more machine-learned models determining the plurality of predicted reformatted content segments is achieved. For example, the loss can be minimized until a threshold loss associated with 99% accuracy is achieved by the machine-learned model.

The systems, methods, devices, and/or computer-readable media (e.g., tangible non-transitory computer-readable media) in the disclosed technology can provide a variety of technical effects and benefits including an improvement in the effectiveness with which reformatted content data comprising text, images, audio, and/or video is generated based on the detection, recognition, classification, parsing, and/or transformation of features (e.g., low-level visual features and/or low-level audio features) of content data (e.g., audio-video content such as streaming video content and/or audio webcast content). Further, the reformatted content of the disclosed technology can offer more information-dense content in which relevant information is more efficiently arranged based on the transformation of the content on which the reformatted content is based. Further, the disclosed technology can improve the effectiveness with which computational resources are used by leveraging one or more machine-learned models that are able to determine features (e.g., visual features and/or audio features) and generate more compact reformatted content that occupies less storage space.

The disclosed technology can automatically transform content as part of generating reformatted content. For example, audio-video content that was originally viewed via a streaming content service can be automatically classified. Based on the class associated with the reformatted content, one or more machine-learned models can be configured and/or trained to generate reformatted content which can include text and images that capture relevant portions of the original audio-video content in a more compact form. In this way, a user can view reformatted content that may be more information dense and take less time to consume than the audio-video content on which the reformatted content is based.

Further, the disclosed technology can generate content information that can be used to index and/or retrieve the content on which the reformatted content is based, which can improve the effectiveness with which the content on which the reformatted content is based is searched for, retrieved, and/or distributed. For example, the reformatted content can comprise reformatted content embeddings that can be searched and used to improve the search and/or relevance of searches (e.g., embeddings-based searches).

Additionally, the reformatted content can include transformed content in which extraneous and/or misleading content (e.g., misleading video titles) is reduced. By selectively transforming content to the reformatted content can include class-based content in which text, images, audio, and/or video is arranged in a way that highlights relevant content and presents the reformatted content in a way that facilitates consumption of the reformatted content. As such, the disclosed technology can allow the user of a computing system to perform the technical task of generating reformatted content based on the use of machine-learned models that are configured and/or trained to generate reformatted content data based on content data. As a result, users can be provided with the specific benefits of improved performance (search performance), more compact content that may require a lower time to consume, and more efficient use of computing system resources including storage resources. Further, any of the specific benefits provided to users can be used to improve the effectiveness of a wide variety of devices and services including services that generate and/or distribute content including video content, audio content, text content, and/or image content. Accordingly, the improvements offered by the disclosed technology can result in tangible benefits to a variety of devices and/or systems including mechanical, electronic, and/or computing systems associated with generating reformatted content.

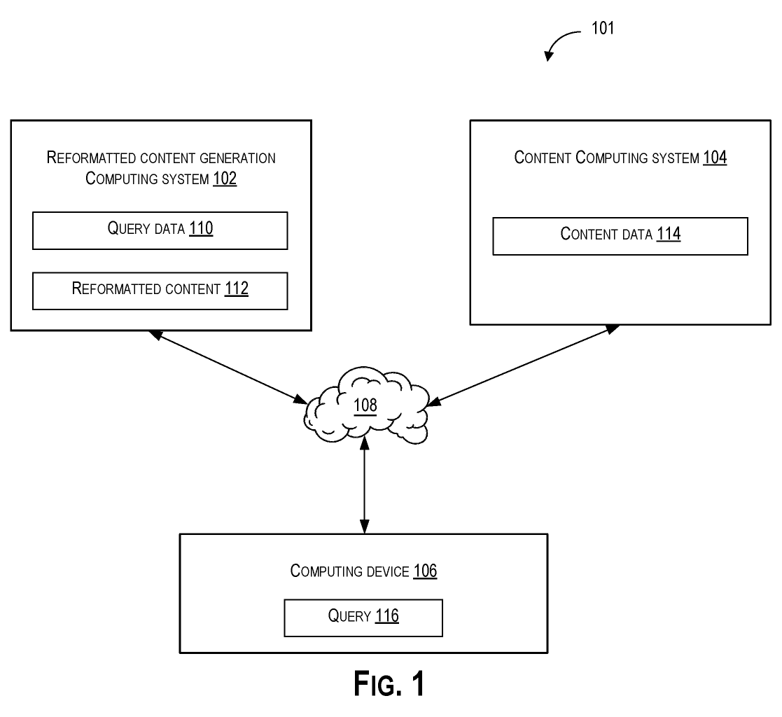

With reference now to the figures, example embodiments of the present disclosure will be discussed in further detail. FIG. 1 depicts a block diagram of an example computing system that can generate reformatted content according to example embodiments of the present disclosure. One or more operations described with respect to a system 101 can be executed and/or implemented on one or more computing devices or computing systems comprising the features and/or capabilities of, for example, the computing device 50, the server computing system 60, the model development platform system 70, and/or the computing device 300. Further, one or more portions of the operations described with respect to the system 101 can be executed or implemented as an algorithm on the hardware devices or systems disclosed herein.

The system 101 comprises reformatted content generation computing system 102, content computing system 104, computing device 106, network 108, query data 110, reformatted content 112, content data 114, and query data 116.

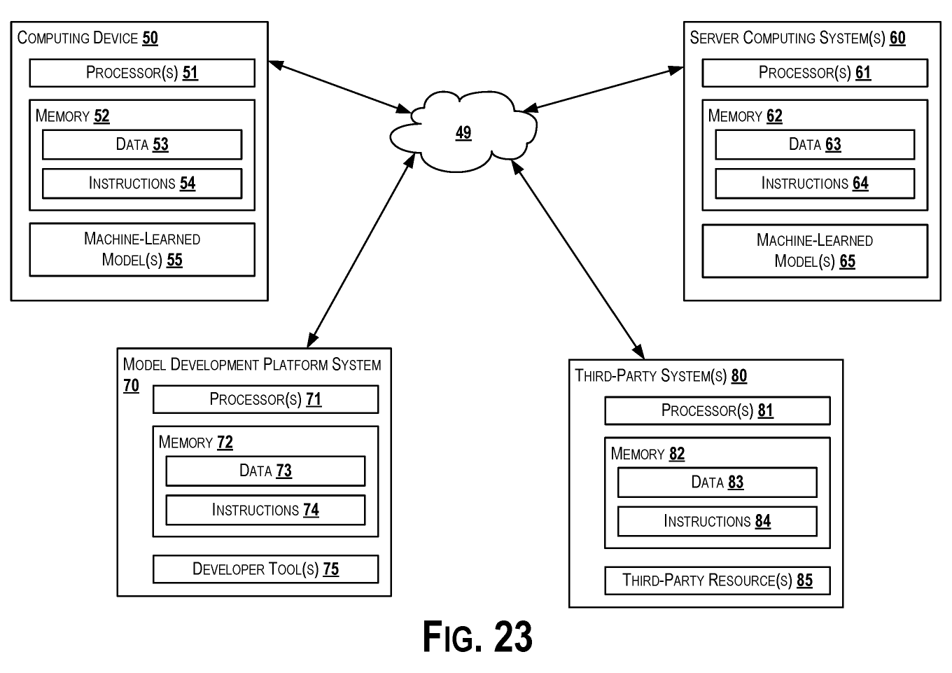

The reformatted content generation computing system 102 can comprise one or more computing devices that are configured to obtain, via the network 108 (e.g., a network with the features and/or capabilities of the network 49 that is described with respect to FIG. 23), the content data 114 from the content computing system 104. For example, the content computing system 104 can host audio-video content that is part of an audio-video content streaming service (e.g., streaming movie clips, television clips, and/or user generated audio-video content).

The reformatted content generation computing system 102 can obtain, via the network 108, the content data 114 based on a query sent from the computing device 106 to the reformatted content generation computing system 102. In some embodiments, the reformatted content generation computing system 102 can obtain one or more portions of the content data 114 based on the query data 116 associated with the computing device 106. The query data 116 can comprise information associated with one or more queries (e.g., one or more search queries) entered into the computing device 106. In some embodiments, the query data 116 can comprise a plurality of queries sent, via the network 108, from the computing device 106 over a predefined time period. The plurality of queries can be included in the query data 110 and used to obtain one or more portions of the content data 114. For example, the query data 116 can be used as an input to one or more machine-learned models that are configured and/or trained to determine one or more classes of content (e.g., sports content, news content, educational content, and/or professional development content) included in search queries sent from the computing device 106. The one or more classes of content can be used to determine one or more portions of the content data 114 to obtain from the content computing system 104.

The reformatted content generation computing system 102 can generate the reformatted content 112 based on the query data 110 and the content data 114. For example, based on the query data 110 comprising a single search query sent from the computing device 106, the reformatted content generation computing system 102 can obtain content data 114 associated with the search query. Further, based on the query data 110 comprising one or more queries (e.g., one or more historical search queries from the past month) the reformatted content generation computing system 102 can obtain a plurality of portions of the content data 114 (e.g., multiple audio-video segments). The reformatted content generation computing system 102 can input the query data 110 and/or the content data 114 into one or more machine-learned models that may be implemented on the reformatted content generation computing system 102. The one or more machine-learned models can generate output comprising the reformatted content 112, which can be sent to the computing device 106 (e.g., a mobile computing device). For example, the reformatted content 112 can be outputted on a display device of the computing device 106 and can be included in search results and/or as part of a discovery feed that is based on historical search queries.

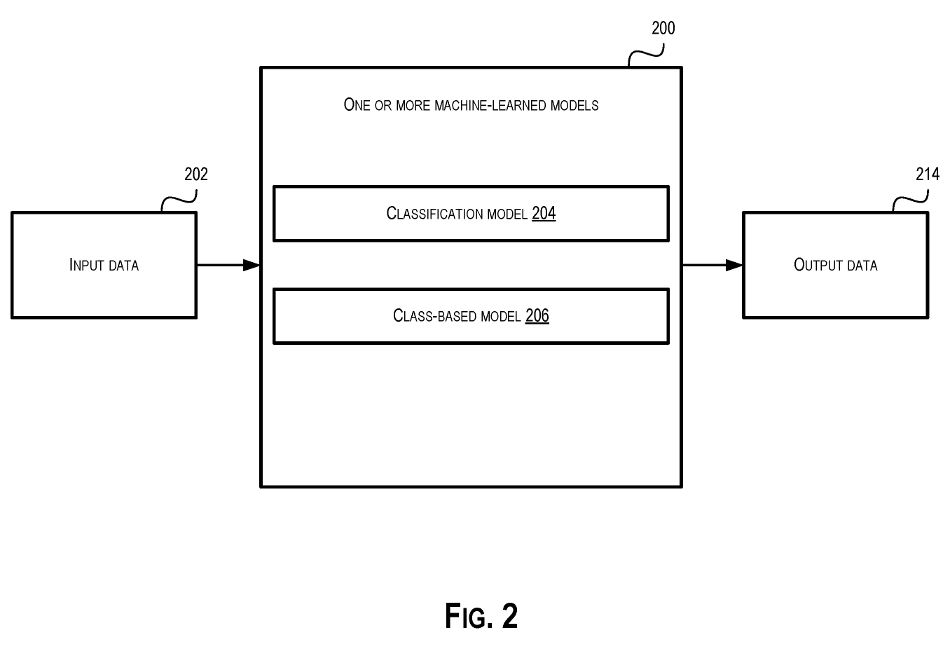

FIG. 2 depicts a block diagram of examples of machine-learned models according to example embodiments of the present disclosure. One or more operations described with respect to one or more machine-learned models 200 can be executed and/or implemented on one or more computing devices or computing systems comprising the features and/or capabilities of, for example, the computing device 50, the server computing system 60, the model development platform system 70, and/or the computing device 300. Further, one or more portions of the operations described with respect to the one or more machine-learned models 200 can be executed or implemented as an algorithm on the hardware devices or systems disclosed herein.

In some implementations, the one or more machine-learned models 200 can be trained to receive input data 202 that can comprise content data and/or query data. As a result of receipt of the input data 202 the one or more machine-learned models 200 can generate output data 214 that can comprise reformatted content data that can comprise a plurality of reformatted content segments.

In some implementations, the one or more machine-learned models 200 can include a classification model 204 that is operable to generate output data 214 comprising classification output associated with one or more classes of content based on the input data 202 (e.g., input data comprising content data and/or query data). Further, the one or more machine-learned models 200 can include a class-based model 206 that is operable to generate output data 214 comprising reformatted content data based on the input data 202 (e.g., input data comprising content data and/or query data). In some embodiments, the class-based model 206 can generate the output data 214 based on the input data 202 and/or the classification output of the classification model 204.

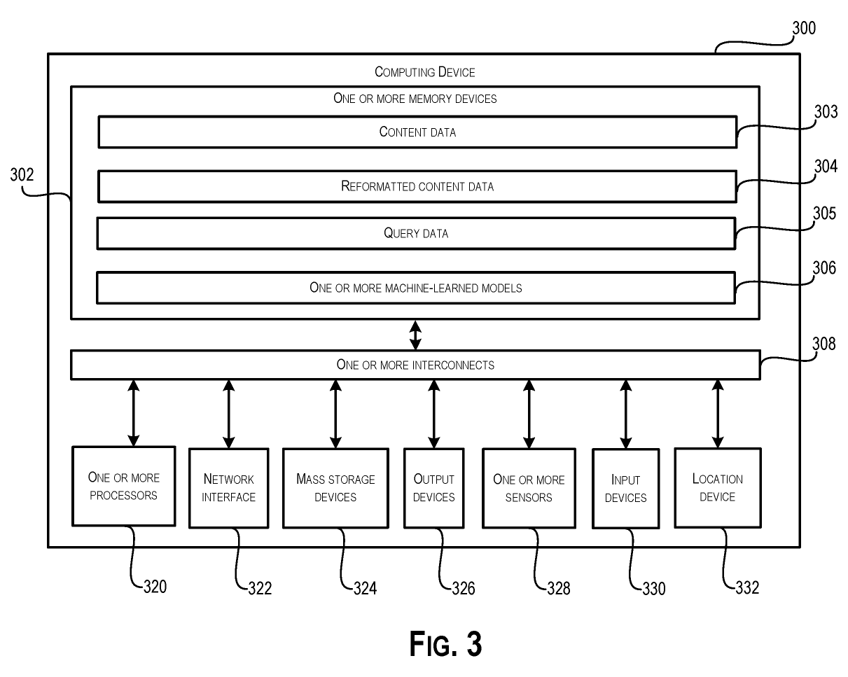

FIG. 3 depicts an example of a computing device according to example embodiments of the present disclosure. A computing device 300 can include one or more features and/or capabilities of the computing device 50, the server computing system 60, and/or the model development platform system 70. Furthermore, the computing device 300 can perform one or more actions and/or operations performed by the computing device 50, the server computing system 60, and/or the model development platform system 70, which are described with respect to FIG. 23.

As shown in FIG. 3, the computing device 300 can include one or more memory devices 302, content data 303, reformatted content data 304, query data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., reformatted content data) based on data (e.g., content data) of the computing device 300 and/or data that is received from another computing device (e.g., content data that is generated by a remote computing device).

The one or more memory devices 302 can store information and/or data (e.g., the content data 303, the reformatted content data 304, the query data 305, and/or the one or more machine-learned models 306). Further, the one or more memory devices 302 can include one or more computer-readable media (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including obtaining content data; determining, based on inputting the content data into one or more machine-learned classification models, one or more classes associated with the plurality of content segments; generating, based on inputting the plurality of content segments into one or more class-based machine-learned models, reformatted content data comprising a plurality of reformatted content segments; obtaining query data comprising one or more queries; determining one or more reformatted content segments associated with the one or more queries; and generating reformatted content based on the one or more reformatted content segments associated with the one or more queries.

The content data 303 can include one or more portions of data (e.g., the data 53, the data 63, the data 73, and/or the data 83, which are depicted in FIG. 23) and/or instructions (e.g., the instructions 54, the instructions 64, the instructions 74, and/or the instructions 84 which are depicted in FIG. 23) that are stored in the memory 52, the memory 62, the memory 72, and/or the memory 82, respectively. The content data 303 can comprise a plurality of content segments. The plurality of content segments can comprise audio-video segments, video segments, audio segments, text segments, and/or images. For example, the content data 303 can comprise a plurality of content segments comprising audio-video content segments from a streaming video. In some embodiments, the content data 303 can be obtained from one or more computing systems (e.g., the server computing system 60 that is depicted in FIG. 23) which can include one or more computing systems that are remote from the computing device 300.

The reformatted content data 304 can include one or more portions of data (the data 53, the data 63, the data 73, and/or the data 83, which are depicted in FIG. 23) and/or instructions (e.g., the instructions 54, the instructions 64, the instructions 74, and/or the instructions 84 which are depicted in FIG. 23) that are stored in the memory 52, the memory 62, the memory 72, and/or the memory 82, respectively. In some embodiments, the reformatted content data 304 can be received from one or more computing systems (e.g., the server computing system 60 that is depicted in FIG. 23) which can include one or more computing systems that are remote from the computing device 300. The reformatted content data 304 can comprise a plurality of reformatted content segments (e.g., reformatted content segments comprising text content and/or image content) that correspond to and/or are based on the plurality of content segments of the content data 303.

The query data 305 can include one or more portions of data (e.g., the data 53, the data 63, the data 73, and/or the data 83, which are depicted in FIG. 23) and/or instructions (e.g., the instructions 54, the instructions 64, the instructions 74, and/or the instructions 84 which are depicted in FIG. 23) that are stored in the memory 52, the memory 62, the memory 72, and/or the memory 82, respectively. Furthermore, the query data 305 can be based on one or more queries (e.g., search queries) and can include information associated with the content data 303 and/or the reformatted content data 304. In some embodiments, the query data 305 can be obtained from one or more computing systems (e.g., the server computing system 60 that is depicted in FIG. 23) which can include one or more computing systems that are remote from the computing device 300.

The one or more machine-learned models 306 (e.g., the one or more machine-learned models 55, the one or more machine-learned models 65, and/or the one or more machine-learned models 200) can include one or more portions of the data 53, the data 63, the data 73, and/or the data 83, which are depicted in FIG. 23 and/or instructions (e.g., the instructions 54, the instructions 64, the instructions 74, and/or the instructions 84 which are depicted in FIG. 23) that are stored in the memory 52, the memory 62, the memory 72, and/or the memory 82, respectively. Furthermore, the one or more machine-learned models 306 can be configured and/or trained to perform operations comprising obtaining content data; determining, based on inputting the content data into one or more machine-learned classification models, one or more classes associated with the plurality of content segments; generating, based on inputting the plurality of content segments into one or more class-based machine-learned models, reformatted content data comprising a plurality of reformatted content segments; obtaining query data comprising one or more queries; determining one or more reformatted content segments associated with the one or more queries; and generating reformatted content based on the one or more reformatted content segments associated with the one or more queries. In some embodiments, the one or more machine-learned models 306 can be received from one or more computing systems (e.g., the server computing system 60 that is depicted in FIG. 23) which can include one or more computing systems that are remote from the computing device 300.

The one or more interconnects 308 can include one or more interconnects or buses that can be used to send and/or receive one or more signals (e.g., electronic signals) and/or data (e.g., the content data 303, the reformatted content data 304, the query data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further, the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the content data 303, the reformatted content data 304, the query data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., content data) from other computing devices. The one or more mass storage devices 324 (e.g., a hard disk drive and/or a solid-state drive) can be used to store data including the reformatted content data 304 and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch-sensitive display that is used to output an interface (e.g., a user interface) that can be configured to display indications based on the content data 303, the reformatted content data 304, and/or the query data 305. In some embodiments, the one or more output devices can comprise an extended reality (XR) device, an augmented reality (AR) device, and/or a virtual reality (VR) device. For example, the one or more output devices 326 can comprise an extended reality headset or augmented reality glasses that can be used to display images, display video, and/or output audio.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch-sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, and network interfaces, which can be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the content data 303, the reformatted content data 304, and/or the query data 305. The one or more memory devices 302 can be used to operate various applications including a mobile operating system developed specifically for mobile devices. As such, the one or more memory devices 302 can store instructions that allow the software applications to access data including data associated with the classification of content data and/or the generation of reformatted content data. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 23. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a global positioning system (GPS), a Galileo positioning system, the Global Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

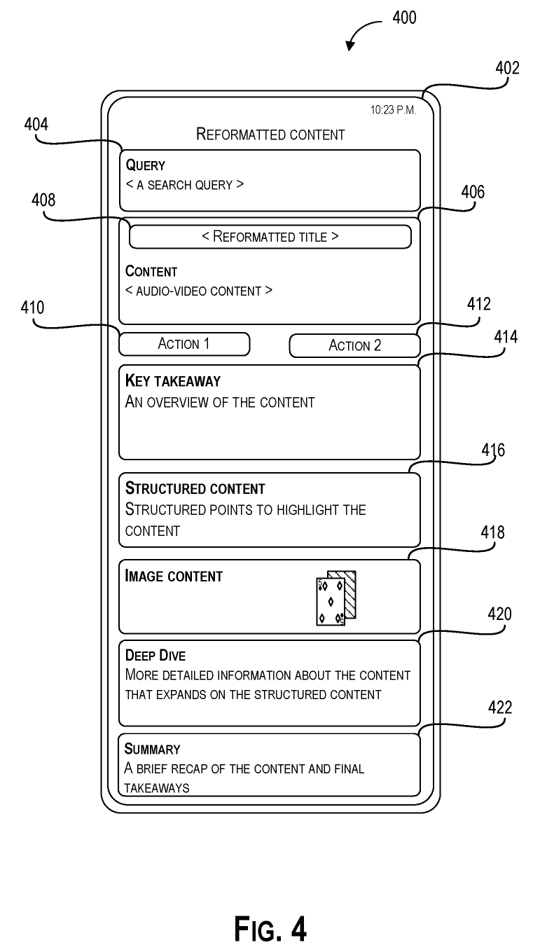

FIG. 4 depicts an example of generating reformatted content according to example embodiments of the present disclosure. A computing device 400 can include one or more features and/or capabilities of the computing device 50, the server computing system 60, and/or the model development platform system 70. The computing device 400 can include a display component 402, query 404, content 406, reformatted title 408, reformatted interface element 410, reformatted interface element 412, reformatted key takeaway content 414, reformatted text content 416, reformatted image content 418, reformatted deep dive content 420, and reformatted summary content 422.

The computing device 400 can be configured to perform one or more operations comprising sending, obtaining, processing, and/or generating data comprising content data (e.g., content data associated with the content 406), reformatted content data, query data (e.g., query data associated with the query 404), and/or other data received by the computing device 400. For example, the reformatted content data can be based on content data associated with the content 406 and can comprise and/or be associated with the reformatted title 408, the reformatted interface element 410, the reformatted interface element 412, the reformatted key takeaway content 414, the reformatted text content 416, the reformatted image content 418, and/or the reformatted deep dive content 420, and/or the reformatted summary content 422.

The query 404 (e.g., a query sent to a computing device that implements one or more search engines) can comprise a search query that is used to retrieve content and/or reformatted content. For example, the query 404 can comprise a request for instructions to perform a particular card trick. The computing device 400 can generate query data that can be sent to a remote computing system that can provide content data and/or reformatted content data.

In some embodiments, the query 404 can be optional and the reformatted data can be generated without generating or using the query 404. For example, the reformatted content data received by the computing device 400 can be sent from a remote computing device associated with a website (e.g., a website of a streaming video service) that automatically generates content based on either a user’s preferences (e.g., the preferences of a user logged into the streaming video service) or default reformatted content that can be provided (e.g., provided periodically) to one or more web pages of a website (e.g., a home page of a website). In some embodiments, the computing device 400 can generate reformatted content data locally (e.g., generate reformatted content data using one or more processors of the computing device 400) and/or receive reformatted content data from another computing device (e.g., a remote computing device such as the server computing system 60 that is described with respect to FIG. 23).

The content 406 can be based on content data which can be associated with audio-video content. The content 406 can comprise a thumbnail image of the audio-video content. For example, if the audio-video content associated with the content 406 comprises a review of a laptop computer, the content 406 can comprise a still image or video captured from the audio-video content. In this example, the content can comprise an image from the audio-video content associated with an instructional video showing how to perform a card trick.

In some embodiments, the computing device 400 can use content data (e.g., content data associated with the content 406) as an input to one or more machine-learned models (e.g., one or more machine-learned classification models and/or one or more class-based machine-learned models) that can be implemented on the computing device 400 and/or that are implemented on a remote computing device that is able to send data to and/or receive data from the computing device 400. The one or more machine-learned models can be configured and/or trained to detect, recognize, classify, and/or parse one or more features of the content data. For example, the one or more machine-learned models can recognize and/or classify one or more features of the content 406 and generate reformatted content. The computing device 400 can generate the reformatted title 408 which can include the actual title from the content 406 or a title generated based on the content data. For example, the one or more machine-learned models can be configured and/or trained to generate the reformatted title 408 based on the content data. The reformatted title 408 can comprise the name of the particular trick requested in the query 404.

The reformatted content can comprise the reformatted key takeaway content 414 which includes an overview of the content. The reformatted key takeaway content 414 can include a brief summary of the content and can include relevant information associated with the content. Further, the reformatted content can comprise the reformatted text content 416 which indicates structured points to highlight the content. The reformatted text content 416 can include structured data such as bullet points and/or numbered lists that can be used to provide relevant and concise information based on the reformatted content. Further, the reformatted image content 418 can comprise one or more images associated with the content. In this example, the reformatted image content comprises an image of two playing cards and the content 406 can be based on a how-to video associated with card tricks. The reformatted image content 418 can comprise an image from the source content, an image from non-source content (e.g., an image from the website of a business associated with the source content), and/or an image that was generated by one or more machine-learned models that are configured and/or trained to generate images (e.g., generative machine-learned models that are configured and/or trained to generate images of particular types of objects based on the query 404 or another input such as a prompt).

The reformatted content can comprise the reformatted deep dive content 420 which can comprise more detailed information about the content and expand on the structured content. The reformatted deep dive content 420 can include more comprehensive information associated with the content and can expand on the reformatted text content and provide a more detailed review of the subject matter.

Further, the computing device can generate the reformatted interface element 410 which comprises an interface element (“ACTION 1”) and/or the reformatted interface element 412 which comprises an interface element (“ACTION 2”) that can be displayed on the display component 402. The reformatted interface element 410 and/or the reformatted interface element 412 can be configured to perform various actions comprising sharing the content 406, sharing reformatted content, saving the reformatted content, and/or viewing the content 406.

The reformatted interface element 410 and/or the reformatted interface element 412 can be configured to perform an action (e.g., sharing the reformatted content or saving the reformatted content) based on the computing device 400 detecting an input to the reformatted interface element 410 and/or the reformatted interface element 412. For example, the computing device can detect an input from an input device or a user touching the portion of the user interface that comprises the reformatted interface element 410 and/or the reformatted interface element 412.

The reformatted summary content 422 can include a summary of the reformatted content that can include a brief recap and/or final takeaway associated with the content 406. In some embodiments, the reformatted content can also include various information associated with the content 406 including a date on which the content was made public, a name of the creator of the content associated with the content, and/or contact information associated with the content 406.

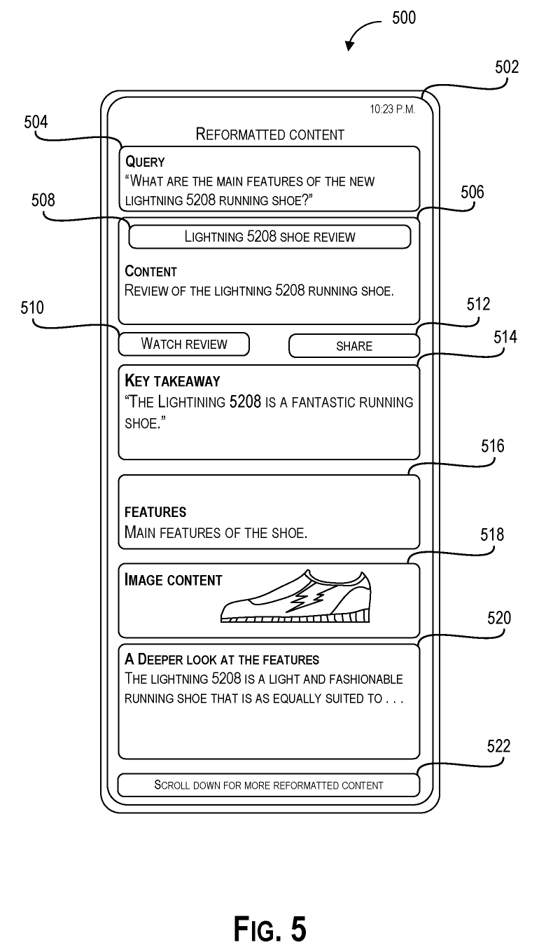

FIG. 5 depicts an example of generating feature-based reformatted content according to example embodiments of the present disclosure. A computing device 500 can include one or more features and/or capabilities of the computing device 50, the server computing system 60, the model development platform system 70, the computing device 300, and/or the computing device 400.

The computing device 500 can include a display component 502, query 504, content 506, reformatted title 508, reformatted interface element 510, reformatted interface element 512, reformatted key takeaway content 514, reformatted text content 516, reformatted image content 518, reformatted deep dive content 520, and interface element 522.

The computing device 500 can be configured to perform one or more operations comprising sending, obtaining, processing, and/or generating data comprising content data (e.g., content data associated with the content 506), reformatted content data, query data (e.g., query data associated with the query 504), and/or other data received by the computing device 500. For example, the reformatted content data can be based on content data associated with the content 506 and can comprise and/or be associated with the reformatted title 508, the reformatted interface element 510, the reformatted interface element 512, the reformatted key takeaway content 514, the reformatted text content 516, the reformatted image content 518, and/or the reformatted deep dive content 520.

In this example, the computing device 500 has been used to generate the query 504 comprising “WHAT ARE THE MAIN FEATURES OF THE NEW LIGHTNING 5208 RUNNING SHOE?” In response to sending the query 504 to a remote computing system that can provide content data and/or reformatted content data the computing system can receive data comprising content data associated with the content 506 (e.g., content comprising “REVIEW OF THE LIGHTNING 5208 RUNNING SHOE”), which can comprise audio-video content associated with the query 504. The content 506 can be based on content data and can be associated with audio-video content. Further, the content 506 can comprise a thumbnail image of the audio-video content associated with a review of the lightning 5208 running shoe.

In some embodiments, the computing device 500 can use content data (e.g., content data associated with the content 506) as an input to one or more machine-learned models (e.g., one or more machine-learned classification models and/or one or more class-based machine-learned models) that can be implemented on the computing device 500 and/or that are implemented on a remote computing device that is able to send data to and/or receive data from the computing device 500. The one or more machine-learned models can be configured and/or trained to detect, recognize, classify, and/or parse one or more features of the content data. For example, the one or more machine-learned models can recognize and/or classify one or more features of the content 506 and generate reformatted content comprising features (e.g., main features discussed in the content 506) of a particular running shoe. The computing device 500 can generate the reformatted title 508 which can include the actual title from the content 506 or a title generated based on the content data. Further, the one or more machine-learned models can be configured and/or trained to generate the reformatted title 508 based on the content data. The reformatted title 508 can comprise the title (“LIGHTNING 5208 SHOE REVIEW”) of the of the content data associated with the content 506.

The reformatted content can comprise the reformatted key takeaway content 514 which indicates “THE LIGHTNING 5208 IS A FANTASTIC RUNNING SHOE.” The reformatted key takeaway 514 can include a brief summary of the content and can include relevant information associated with the content. Further, the reformatted content can comprise the reformatted text content 516 which indicates “MAIN FEATURES OF THE SHOE.” The reformatted text content 516 can include structured data in which features are divided into categories that have corresponding information (e.g., a durability feature next to a brief evaluation of the durability of the shoe, a weight feature next to a weight of the shoe, and/or a price feature next to the price of the shoe). Further, the reformatted image content 518 can comprise an image (e.g., an image of the lightning 5208 running shoe) that is associated with the content. The reformatted image content 518 can comprise an image from the source content (e.g., an image from the audio-video content of the lightning 5208 running shoe review), an image from non-source content (e.g., an image from the shoe maker’s website), and/or an image that was generated by one or more machine-learned models that are configured and/or trained to generate images (e.g., generative machine-learned models that are configured and/or trained to generate images comprising images of clothing and/or footwear based on the query 504 or another input such as a prompt to generate an image of a particular model of running shoe).

The reformatted content can comprise the reformatted deep dive content 520 which indicates “A DEEPER LOOK AT THE FEATURES: THE LIGHTNING 5208 IS A LIGHT AND FASHIONABLE RUNNING SHOE THAT IS AS EQUALLY SUITED TO . . .” The reformatted deep dive content 520 can include more comprehensive information associated with the content and can expand on the reformatted text content and provide a more detailed review of the running shoe that can include additional features of the running shoe such as comfort, durability, price, and/or performance.

Further, the computing device can generate the reformatted interface element 510 which comprises an interface element (“WATCH CONTENT”) that can be displayed on the display component 502 and used to access the source of the content associated with the content 506 and view the review of the running shoe. Further, the computing device can generate the reformatted interface element 512 which comprises an interface element (“SHARE”) that can be displayed on the display component 502 and used to share the reformatted content (e.g., share the reformatted content with other people interested in the shoe).

The reformatted interface element 510, the reformatted interface element 512, and/or the interface element 522 can perform an action (e.g., sharing the reformatted content or scrolling the reformatted content) based on the computing device 500 detecting an input to the reformatted interface element 510, the reformatted interface element 512, and/or the interface element 522. Further, the interface element 522 which indicates “SCROLL DOWN FOR MORE REFORMATTED CONTENT” can be used to show more of the reformatted content on the display component 502.

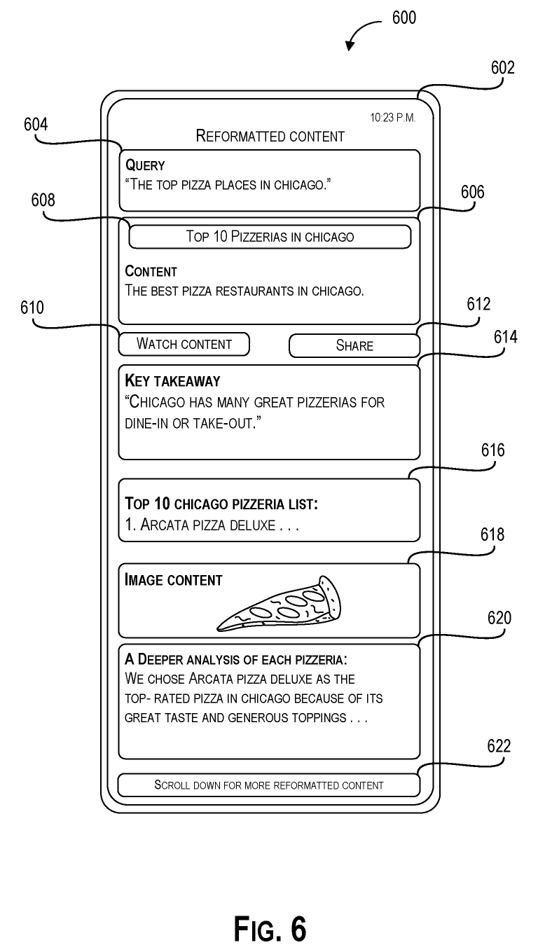

FIG. 6 depicts an example of generating ranking-based reformatted content according to example embodiments of the present disclosure. A computing device 600 can include one or more features and/or capabilities of the computing device 50, the server computing system 60, the model development platform system 70, the computing device 300, and/or the computing device 400.

The computing device 600 can include a display component 602, query 604, content 606, reformatted title 608, reformatted interface element 610, reformatted interface element 612, reformatted key takeaway content 614, reformatted text content 616, reformatted image content 618, reformatted deep dive content 620, and interface element 622.

The computing device 600 can be configured to perform one or more operations comprising sending, obtaining, processing, and/or generating data comprising content data (e.g., content data based on the content 606), reformatted content data, query data (e.g., query data associated with the query 604), and/or other data received by the computing device 600. For example, the reformatted content data can be based on content data associated with the content 606 and can comprise and/or be associated with the reformatted title 608, the reformatted interface element 610, the reformatted interface element 612, the reformatted key takeaway content 614, the reformatted text content 616, the reformatted image content 618, and/or the reformatted deep dive content 620.

In this example, the computing device 600 has been used to generate the query 604 (e.g., a query sent to a search engine) comprising “THE TOP PIZZA PLACES IN CHICAGO.” In response to sending the query 604 to a remote computing system that can provide content data and/or reformatted content data the computing system can receive data comprising content data associated with the content 606 (e.g., content associated with “THE BEST PIZZA RESTAURANTS IN CHICAGO”), which can comprise audio-video content associated with the query 604.

In some embodiments, the computing device 600 can use content data (e.g., content data associated with the content 606) as an input to one or more machine-learned models (e.g., one or more machine-learned classification models and/or one or more class-based machine-learned models) that can be implemented on the computing device 600 and/or that are implemented on a remote computing device that is able to send data to and/or receive data from the computing device 600. The one or more machine-learned models can be configured and/or trained to detect, recognize, classify, and/or parse one or more features of the content data. For example, the one or more machine-learned models can recognize and/or classify one or more features of the content 606 and generate reformatted content comprising a ranking (e.g., top ten ranking) of pizzerias in Chicago. The computing device 600 can generate the reformatted title 608 which can include the actual title from the content 606 or a title generated based on the content data. Further, the one or more machine-learned models can be configured and/or trained to generate the reformatted title 608 based on the content data. The reformatted title 608 can comprise a reformatted title (“TOP 10 PIZZERIAS IN CHICAGO”) that is based on the content data associated with the content 606.

The reformatted content can comprise the reformatted key takeaway content 614 which indicates “CHICAGO HAS MANY GREAT PIZZERIAS FOR DINE-IN OR TAKE-OUT.” The reformatted key takeaway 614 can include a brief summary of the content and can include relevant information associated with the content. Further, the reformatted content can comprise the reformatted text content 616 which indicates “TOP 10 CHICAGO PIZZERIA LIST: 1. ARCATA PIZZA DELUXE.” The reformatted text content 616 can include structured data such as an ordered list (from one to ten) of the pizzerias that can be used to present the reformatted content. Further, the reformatted image content 618 can comprise an image (e.g., an image of a slice of pizza) that is associated with the content. The reformatted image content 618 can comprise an image from the source content (e.g., an image from the audio-video content of the pizzeria review), an image from non-source content (e.g., an image from the pizzeria website), and/or an image that was generated by one or more machine-learned models that are configured and/or trained to generate images (e.g., generative machine-learned models that are configured and/or trained to generate images comprising images of food based on the query 604 or another input such as a prompt).

The reformatted content can comprise the reformatted deep dive content 620 which indicates “A DEEPER ANALYSIS OF EACH PIZZERIA: WE CHOSE ARCATA PIZZA DELUXE AS THE TOP-RATED PIZZA IN CHICAGO BECAUSE OF ITS GREAT TASTE AND GENEROUS TOPPINGS . . .” The reformatted deep dive content 620 can include more comprehensive information associated with the content and can expand on the reformatted text content and provide a more detailed review of the pizzerias (e.g., individual reviews of each of the pizzerias in the top ten list).

Further, the computing device can generate the reformatted interface element 610 which comprises an interface element (“WATCH CONTENT”) that can be displayed on the display component 602. In this example, the reformatted interface element 610 can be used to access the source of the content associated with the content 606 (e.g., access the audio-video content associated with the content 606 via a link to the website that hosts the audio-video content). Further, the computing device can generate the reformatted interface element 612 which comprises an interface element (“SHARE”) that can be displayed on the display component 602. In this example, the reformatted interface element 612 can be used to share the reformatted content (e.g., use one or more applications that can comprise social media application, a text message application, and/or an email application to send the reformatted content or a link associated with the reformatted content to other computing devices). The interface element 622 can be used to display different portions of the reformatted content that may not be immediately visible on the display component 602.

The reformatted interface element 610, the reformatted interface element 612, and/or the interface element 622 can perform an action (e.g., sharing the reformatted content or scrolling the reformatted content) based on the computing device 600 detecting an input to the reformatted interface element 610, the reformatted interface element 612, and/or the interface element 622. For example, the computing device can detect an input from an input device or a user touching the portion of the user interface that comprises the reformatted interface element 610, the reformatted interface element 612, or the interface element 622.

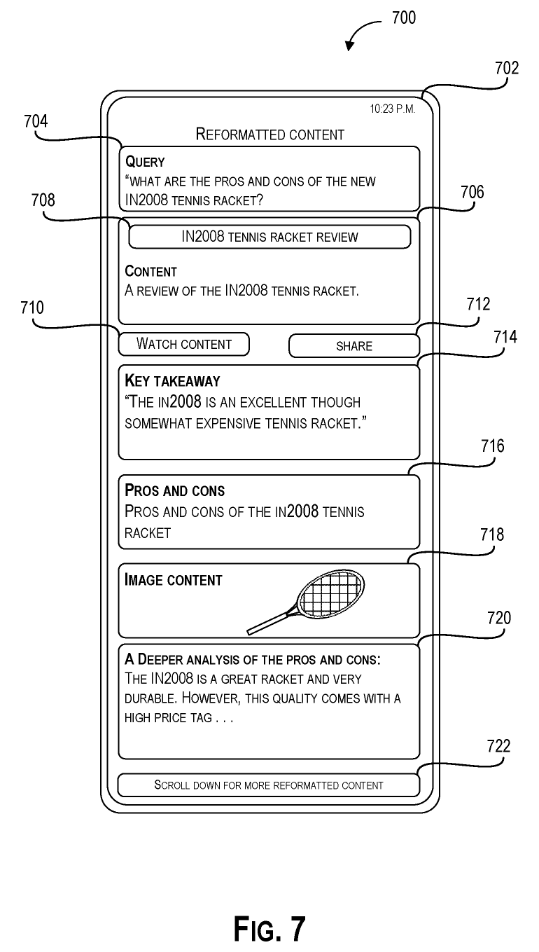

FIG. 7 depicts an example of generating evaluation-based reformatted content according to example embodiments of the present disclosure. A computing device 700 can include one or more features and/or capabilities of the computing device 50, the server computing system 60, the model development platform system 70, the computing device 300, and/or the computing device 400.

The computing device 700 can include a display component 702, query 704, content 706, reformatted title 708, reformatted interface element 710, reformatted interface element 712, reformatted key takeaway content 714, reformatted text content 716, reformatted image content 718, reformatted deep dive content 720, and interface element 722.

The computing device 700 can be configured to perform one or more operations comprising sending, obtaining, processing, and/or generating data comprising content data (e.g., content data associated with the content 706), reformatted content data, query data (e.g., query data associated with the query 704), and/or other data received by the computing device 700. For example, the reformatted content data can be based on content data associated with the content 706 and can comprise and/or be associated with the reformatted title 708, the reformatted interface element 710, the reformatted interface element 712, the reformatted key takeaway content 714, the reformatted text content 716, the reformatted image content 718, and/or the reformatted deep dive content 720.

In this example, the computing device 700 has been used to generate the query 704 comprising “WHAT ARE THE PROS AND CONS OF THE NEW IN2008 TENNIS RACKET?” In response to sending the query 704 to a remote computing system that can provide content data and/or reformatted content data the computing system can receive data comprising content data associated with the content 706 (e.g., content comprising “A REVIEW OF THE IN2008 TENNIS RACKET”), which can comprise audio-video content associated with the query 704. The content 706 can be based on content data and can be associated with audio-video content. Further, the content 706 can comprise a thumbnail image of the audio-video content associated with a review of the IN2008 tennis racket.

In some embodiments, the computing device 700 can use content data (e.g., content data associated with the content 706) as an input to one or more machine-learned models (e.g., one or more machine-learned classification models and/or one or more class-based machine-learned models) that can be implemented on the computing device 700 and/or that are implemented on a remote computing device that is able to send data to and/or receive data from the computing device 700. The one or more machine-learned models can be configured and/or trained to detect, recognize, classify, and/or parse one or more features of the content data. For example, the one or more machine-learned models can recognize and/or classify one or more features of the content 706 and generate reformatted content comprising pros and cons of the IN2008 tennis racket. Further, the one or more machine-learned models can be configured and/or trained to generate the reformatted title 708 based on the content data. The reformatted title 708 can comprise a reformatted title (“IN2008 TENNIS RACKET REVIEW”) that is based on the content data associated with the content 706.

The reformatted content can comprise the reformatted key takeaway content 714 which indicates “THE IN2008 IS AN EXCELLENT THOUGH SOMEWHAT EXPENSIVE TENNIS RACKET.” The reformatted key takeaway 714 can include a brief summary of the content and can include relevant information associated with the content. Further, the reformatted content can comprise the reformatted text content 716 which indicates “PROS AND CONS OF THE IN2008 TENNIS RACKET.” The reformatted text content 716 can include structured data such as two columns, one column for pros of the tennis racket and another column for cons of the tennis racket, which can be used to present the reformatted content. Further, the reformatted image content 718 can comprise an image (e.g., an image of the IN2008 tennis racket) that is associated with the content. The reformatted image content 718 can comprise an image from the source content (e.g., an image from the audio-video content of the IN2008 tennis racket review), an image from non-source content (e.g., an image from the tennis manufacturer’s website), and/or an image that was generated by one or more machine-learned models that are configured and/or trained to generate images (e.g., generative machine-learned models that are configured and/or trained to generate images comprising images of sporting equipment based on the query 704 or another input such as a prompt to generate an image of a particular model of tennis racket).

The reformatted content can comprise the reformatted deep dive content 720 which indicates “A DEEPER ANALYSIS OF THE PROS AND CONS: THE IN2008 IS A GREAT RACKET AND VERY DURABLE. HOWEVER, THIS QUALITY COMES WITH A HIGH PRICE TAG . . .” The reformatted deep dive content 720 can include more comprehensive information associated with the content and can expand on the reformatted text content and provide a more detailed analysis of the pros and cons of the tennis racket that can include additional pros such as the light weight of the racket and the rackets performance as well as cons such as the racket’s unforgiving characteristics that may make it less suitable for less experienced players.

Further, the computing device can generate the reformatted interface element 710 which comprises an interface element (“WATCH CONTENT”) that can be displayed on the display component 702 and used to access the source of the content associated with the content 706 and view the review of the tennis racket. Further, the computing device can generate the reformatted interface element 712 which comprises an interface element (“SHARE”) that can be displayed on the display component 702 and used to share the reformatted content (e.g., share the reformatted content with other people interested in the tennis racket).

The reformatted interface element 710, the reformatted interface element 712, and/or the interface element 722 can perform an action (e.g., sharing the reformatted content or scrolling the reformatted content) based on the computing device 700 detecting an input to the reformatted interface element 710, the reformatted interface element 712, and/or the interface element 722. Further, the interface element 722 which indicates “SCROLL DOWN FOR MORE REFORMATTED CONTENT” can be used to show more of the reformatted content on the display component 702.

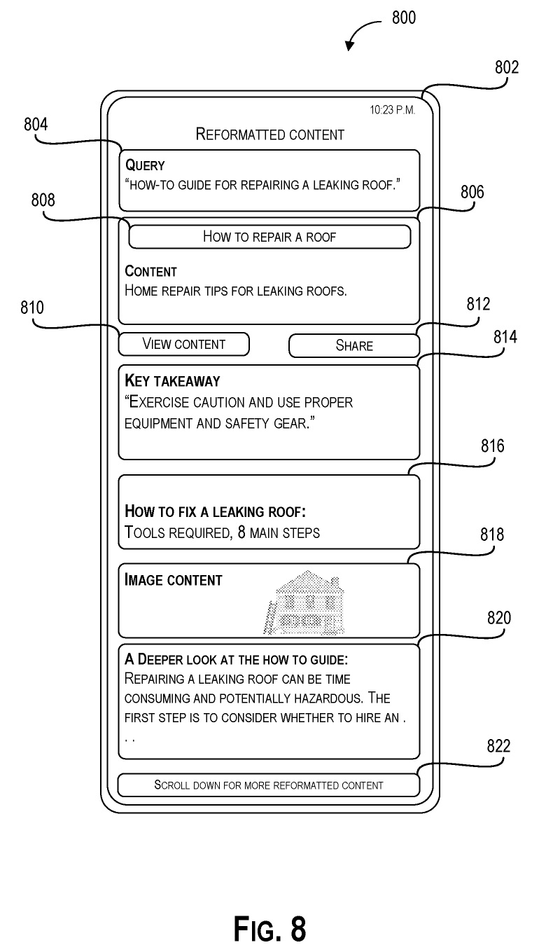

FIG. 8 depicts an example of generating instruction-based reformatted content according to example embodiments of the present disclosure. A computing device 800 can include one or more features and/or capabilities of the computing device 50, the server computing system 60, the model development platform system 70, the computing device 300, and/or the computing device 400.

The computing device 800 can include a display component 802, query 804, content 806, reformatted title 808, reformatted interface element 810, reformatted interface element 812, reformatted key takeaway content 814, reformatted text content 816, reformatted image content 818, reformatted deep dive content 820, and interface element 822.

The computing device 800 can be configured to perform one or more operations comprising sending, obtaining, processing, and/or generating data comprising content data (e.g., content data associated with the content 806), reformatted content data, query data (e.g., query data associated with the query 804), and/or other data received by the computing device 800. For example, the reformatted content data can be based on content data associated with the content 806 and can comprise and/or be associated with the reformatted title 808, the reformatted interface element 810, the reformatted interface element 812, the reformatted key takeaway content 814, the reformatted text content 816, the reformatted image content 818, and/or the reformatted deep dive content 820.

In this example, the computing device 800 has been used to generate the query 804 comprising “HOW-TO GUIDE FOR REPAIRING A LEAKING ROOF.” In response to sending the query 804 to a remote computing system that can provide content data and/or reformatted content data the computing system can receive data comprising content data associated with the content 806 (e.g., content comprising “HOME REPAIR TIPS FOR LEAKING ROOFS”), which can comprise audio-video content associated with the query 804. The content 806 can be based on content data and can be associated with audio-video content. Further, the content 806 can comprise a thumbnail image of the audio-video content associated with a how-to guide to repairing leaking roofs.

In some embodiments, the computing device 800 can use content data (e.g., content data associated with the content 806) as an input to one or more machine-learned models (e.g., one or more machine-learned classification models and/or one or more class-based machine-learned models) that can be implemented on the computing device 800 and/or that are implemented on a remote computing device that is able to send data to and/or receive data from the computing device 800. The one or more machine-learned models can be configured and/or trained to detect, recognize, classify, and/or parse one or more features of the content data. Further, the one or more machine-learned models can recognize and/or classify one or more features of the content 806 and generate reformatted content comprising a how-to guide that includes instructions to repair a leaking roof. Further, the one or more machine-learned models can be configured and/or trained to generate the reformatted title 808 based on the content data. The reformatted title 808 can comprise a reformatted title (“HOW TO REPAIR A ROOF”) that is based on the content data and/or the query 804 associated with the content 806.

The reformatted content can comprise the reformatted key takeaway content 814 which indicates “EXERCISE CAUTION AND USE PROPER EQUIPMENT AND SAFETY GEAR.” The reformatted key takeaway 814 can include a brief summary of the content and can include relevant information associated with the content. Further, the reformatted content can comprise the reformatted text content 816 which indicates “HOW TO FIX A LEAKING ROOF: TOOLS REQUIRED, 8 MAIN STEPS . . .” The reformatted text content 816 can include structured data such as a numbered list of steps in which each step is accompanied by brief instructions that can be used to present the reformatted content. Further, the reformatted image content 818 can comprise an image (e.g., an image of a house with a ladder leaning against the house) that is associated with the content. The reformatted image content 818 can comprise an image from the source content (e.g., an image from the audio-video content of the how-to guide for repairing leaking roofs), an image from non-source content (e.g., an image from a hardware store website from which a ladder and other equipment can be purchased), and/or an image that was generated by one or more machine-learned models that are configured and/or trained to generate images (e.g., generative machine-learned models that are configured and/or trained to generate images comprising images of houses or ladders based on the query 804 or another input such as a prompt to generate an image of a house with a leaking roof and/or equipment such as a ladder).

The reformatted content can comprise the reformatted deep dive content 820 which indicates “A DEEPER LOOK AT THE HOW-TO GUIDE: REPAIRING A LEAKING ROOF CAN BE TIME CONSUMING AND POTENTIALLY HAZARDOUS. THE FIRST STEP IS TO CONSIDER WHETHER TO HIRE AN . . .” The reformatted deep dive content 820 can include more comprehensive information associated with the content and can expand on the reformatted text content and provide step by step instructions on how to repair a leaking roof.

Further, the computing device can generate the reformatted interface element 810 which comprises an interface element (“WATCH CONTENT”) that can be displayed on the display component 802 and used to access the source of the content associated with the content 806 and view the how-to guide. Further, the computing device can generate the reformatted interface element 812 which comprises an interface element (“SHARE”) that can be displayed on the display component 802 and used to share the reformatted content (e.g., share the reformatted content with other people interested in home repair).

The reformatted interface element 810, the reformatted interface element 812, and/or the interface element 822 can perform an action (e.g., sharing the reformatted content or scrolling the reformatted content) based on the computing device 800 detecting an input to the reformatted interface element 810, the reformatted interface element 812, and/or the interface element 822. Further, the interface element 822, which indicates “SCROLL DOWN FOR MORE REFORMATTED CONTENT” can be used to show more of the reformatted content on the display component 802.

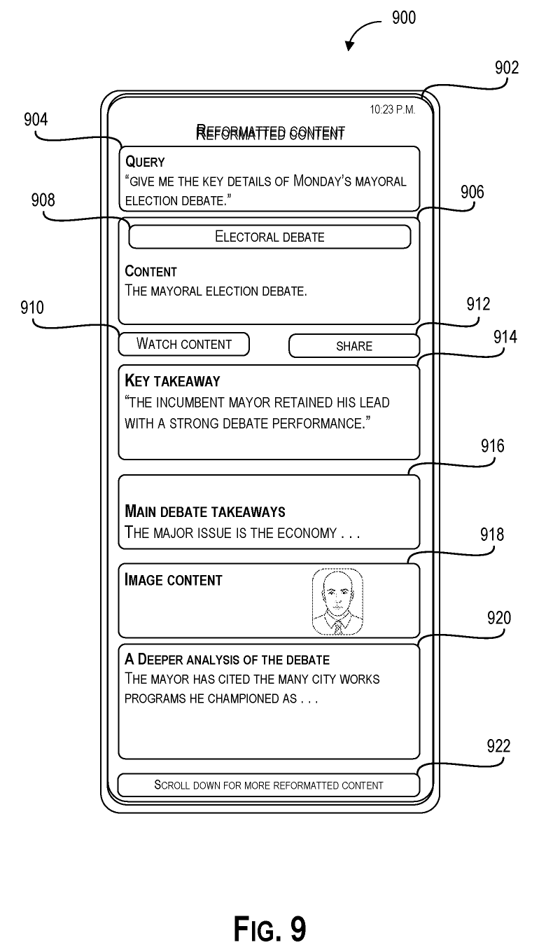

FIG. 9 depicts an example of generating dialogue-based reformatted content according to example embodiments of the present disclosure. A computing device 900 can include one or more features and/or capabilities of the computing device 50, the server computing system 60, the model development platform system 70, the computing device 300, and/or the computing device 400.

The computing device 900 can include a display component 902, query 904, content 906, reformatted title 908, reformatted interface element 910, reformatted interface element 912, reformatted key takeaway content 914, reformatted text content 916, reformatted image content 918, reformatted deep dive content 920, and interface element 922.

The computing device 900 can be configured to perform one or more operations comprising sending, obtaining, processing, and/or generating data comprising content data (e.g., content data associated with the content 906), reformatted content data, query data (e.g., query data associated with the query 904), and/or other data received by the computing device 900. For example, the reformatted content data can be based on content data associated with the content 906 and can comprise and/or be associated with the reformatted title 908, the reformatted interface element 910, the reformatted interface element 912, the reformatted key takeaway content 914, the reformatted text content 916, the reformatted image content 918, and/or the reformatted deep dive content 920.

In this example, the computing device 900 has been used to generate the query 904 comprising “GIVE ME THE KEY DETAILS OF MONDAY’S MAYORAL ELECTION DEBATE.” In response to sending the query 904 to a remote computing system that can provide content data and/or reformatted content data the computing system can receive data comprising content data associated with the content 906 (e.g., content comprising “THE MAYORAL ELECTION DEBATE”), which can comprise audio-video content associated with the query 904. The content 906 can be based on content data and can be associated with audio-video content. Further, the content 906 can comprise a thumbnail image of the audio-video content associated with key details of the mayoral election debate.

In some embodiments, the computing device 900 can use content data (e.g., content data associated with the content 906) as an input to one or more machine-learned models (e.g., one or more machine-learned classification models and/or one or more class-based machine-learned models) that can be implemented on the computing device 900 and/or that are implemented on a remote computing device that is able to send data to and/or receive data from the computing device 900. The one or more machine-learned models can be configured and/or trained to detect, recognize, classify, and/or parse one or more features of the content data. For example, the one or more machine-learned models can recognize and/or classify one or more features of the content 906 and generate reformatted content comprising an analysis of a dialogue between candidates in a mayoral debate. Further, the one or more machine-learned models can be configured and/or trained to generate the reformatted title 908 based on the content data. The reformatted title 908 can comprise a reformatted title (“ELECTORAL DEBATE”) that is based on the content data associated with the content 906.

The reformatted content can comprise the reformatted key takeaway content 914 which indicates “THE INCUMBENT MAYOR RETAINED HIS LEAD WITH A STRONG DEBATE PERFORMANCE.” The reformatted key takeaway 914 can include a brief summary of the content and can include relevant information associated with the content. Further, the reformatted content can comprise the reformatted text content 916 which indicates “THE MAJOR ISSUE IS THE ECONOMY . . .” The reformatted text content 916 can include structured data such as key points from the debate lists that can be used to present the reformatted content. Further, the reformatted image content 918 can comprise an image (e.g., an image of the mayor who participated in the debate) that is associated with the content. The reformatted image content 918 can comprise an image from the source content (e.g., an image from the audio-video content of the debate featuring the mayor), an image from non-source content (e.g., an image from the mayor’s office website), and/or an image that was generated by one or more machine-learned models that are configured and/or trained to generate images (e.g., generative machine-learned models that are configured and/or trained to generate images comprising images of people or faces based on the query 904 or another input such as a prompt to generate an image of a particular person).

The reformatted content can comprise the reformatted deep dive content 920 which indicates “A DEEPER ANALYSIS OF THE DEBATE: THE MAYOR HAS CITED THE MANY CITY WORKS PROGRAMS HE CHAMPIONED AS . . .” The reformatted deep dive content 920 can include more comprehensive information associated with the content and can expand on the reformatted text content and provide a more detailed account of the debate which can include comments by the mayor and other candidates, fact checking of statements made by the candidates, and/or criticism of the candidates’ arguments during the debate.

Further, the computing device can generate the reformatted interface element 910 which comprises an interface element (“WATCH CONTENT”) that can be displayed on the display component 902 and used to access the source of the content associated with the content 906 and view the mayoral debate. Further, the computing device can generate the reformatted interface element 912 which comprises an interface element (“SHARE”) that can be displayed on the display component 902 and used to share the reformatted content (e.g., share the reformatted content with other people interested in the debate).

The reformatted interface element 910, the reformatted interface element 912, and/or the interface element 922 can perform an action (e.g., sharing the reformatted content or scrolling the reformatted content) based on the computing device 900 detecting an input to the reformatted interface element 910, the reformatted interface element 912, and/or the interface element 922. Further, the interface element 922 which indicates “SCROLL DOWN FOR MORE REFORMATTED CONTENT” can be used to show more of the reformatted content on the display component 902.

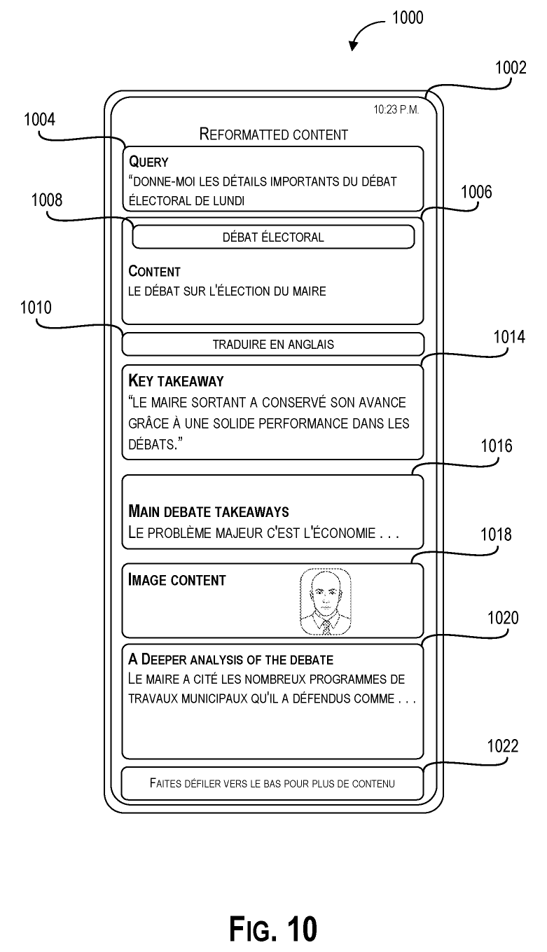

FIG. 10 depicts an example of generating translated reformatted content according to example embodiments of the present disclosure. A computing device 1000 can include one or more features and/or capabilities of the computing device 50, the server computing system 60, the model development platform system 70, the computing device 300, and/or the computing device 400.

The computing device 1000 can include a display component 1002, query 1004, content 1006, reformatted title 1008, reformatted interface element 1010, reformatted key takeaway content 1014, reformatted text content 1016, reformatted image content 1018, reformatted deep dive content 1020, and interface element 1022.

The computing device 1000 can be configured to perform one or more operations comprising generating a translation (e.g., a translation from the language of source content into a different language associated with reformatted content) of reformatted content data. The reformatted content data can be based on content data associated with the content 1006 and can comprise and/or be associated with the reformatted title 1008, the reformatted interface element 1010, the reformatted key takeaway content 1014, the reformatted text content 1016, the reformatted image content 1018, and/or the reformatted deep dive content 1020.

In this example, the computing device 1000 has been used to generate a translation (e.g., a translation from the English language into the French language) of reformatted content that is similar to the reformatted content described with respect to the computing device 900 that is depicted in FIG. 9. The query 1004 comprising “DONNE-MOI LES DÉTAILS IMPORTANTS DU DÉBAT ÉLECTORAL DE LUNDI” is a query provided in the French language. Based on detecting the French language in the query 1004, the computing device 1000 can translate reformatted content that is generated in a language other than French. In response to sending the query 1004 to a remote computing system that can provide content data and/or reformatted content data the computing system can receive data comprising content data associated with the content 1006 (e.g., content comprising “LE DÉBAT SUR L'ÉLECTION DU MAIRE” which is a translation of the original English language content which indicated “THE MAYORAL ELECTION DEBATE”), which can comprise audio-video content associated with the query 1004. The content 1006 can be based on content data and can be associated with audio-video content. Further, the content 1006 can comprise a thumbnail image of the audio-video content associated with the translation of the mayoral election debate.

In some embodiments, the computing device 1000 can use content data (e.g., content data associated with the content 1006) as an input to one or more machine-learned models (e.g., one or more machine-learned classification models and/or one or more class-based machine-learned models) that can be implemented on the computing device 1000 and/or that are implemented on a remote computing device that is able to send data to and/or receive data from the computing device 1000. The one or more machine-learned models can be configured and/or trained to detect, recognize, classify, and/or parse one or more features of the content data. For example, the one or more machine-learned models can recognize and/or classify one or more features of the content 1006 and generate reformatted content comprising an analysis of a mayoral debate. Further, the one or more machine-learned models can be configured and/or trained to translate the reformatted content data from one language to another different language. In this example, the reformatted content has been translated from English to French. Further, the one or more machine-learned models can be configured and/or trained to generate the reformatted title 1008 based on the content data. The reformatted title 1008 can comprise a reformatted title (“DÉBAT ÉLECTORAL” which is a French language translation of the original reformatted title that indicated “ELECTORAL DEBATE”) that is based on the content data associated with the content 1006.

The reformatted content can comprise the reformatted key takeaway content 1014 which indicates “LE MAIRE SORTANT A CONSERVÉ SON AVANCE GRÂCE À UNE SOLIDE PERFORMANCE DANS LES DÉBATS” which is a French language translation of the original English language reformatted key takeaway content which indicated “THE INCUMBENT MAYOR RETAINED HIS LEAD WITH A STRONG DEBATE PERFORMANCE.” The reformatted key takeaway 1014 can include a brief summary of the content and can include relevant information associated with the content. Further, the reformatted content can comprise the reformatted text content 1016 which indicates “LE PROBLÈME MAJEUR C'EST L'ÉCONOMIE . . .” which is a French language translation of the original English language reformatted text content which indicated “THE MAJOR ISSUE IS THE ECONOMY . . .” The reformatted text content 1016 can include structured data such as key remarks from the candidates in the mayoral debate that can be used to present the reformatted content. Further, the reformatted image content 1018 can comprise an image (e.g., an image of the mayor) that is associated with the content. The reformatted image content 1018 can comprise an image from the source content (e.g., an image from the audio-video content of the mayoral debate), an image from non-source content (e.g., an image from the mayoral candidate’s website), and/or an image that was generated by one or more machine-learned models that are configured and/or trained to generate images (e.g., generative machine-learned models that are configured and/or trained to generate images of the mayor based on the query 1004 or another input such as a prompt to generate an image of a particular person).

The reformatted content can comprise the reformatted deep dive content 1020 which indicates “A DEEPER ANALYSIS OF THE DEBATE: LE MAIRE A CITÉ LES NOMBREUX PROGRAMMES DE TRAVAUX MUNICIPAUX QU'IL A DÉFENDUS COMME . . .” which is a partial French language translation of the original English language reformatted deep dive content which indicated “A DEEPER ANALYSIS OF THE DEBATE: THE MAYOR HAS CITED THE MANY CITY WORKS PROGRAMS HE CHAMPIONED AS . . .” The reformatted deep dive content 1020 can include more comprehensive information associated with the content and can expand on the reformatted text content and provide a more detailed account of the debate which can include comments by the mayor and other candidates, fact checking of statements made by the candidates, and/or criticism of the candidates arguments during the debate.

Further, the computing device can generate the reformatted interface element 1010 which comprises an interface element (“TRADUIRE EN ANGLAIS”) which means “TRANSLATE INTO ENGLISH” that can be displayed on the display component 1002 and used to access the source of the content associated with the content 1006 and view the mayoral debate. Based on the computing device 1000 detecting an input to the reformatted interface element 1010, the computing device 1000 can translate the content and/or the reformatted content into the English language if the original language was not English or present the content and/or the reformatted content in the English language if the original language of the content was English. In some embodiments, the computing device 1000 can generate translations (e.g., French language translations) of the headings of the content data and/or the reformatted content data. For example, the computing device 1000 can generate translations of the “QUERY” heading, the “CONTENT” heading, the “KEY TAKEAWAYS” heading, the “MAIN DEBATE TAKEAWAYS” heading, the “IMAGE CONTENT” heading, and/or the “A DEEPER ANALYSIS OF THE DEBATE” heading.

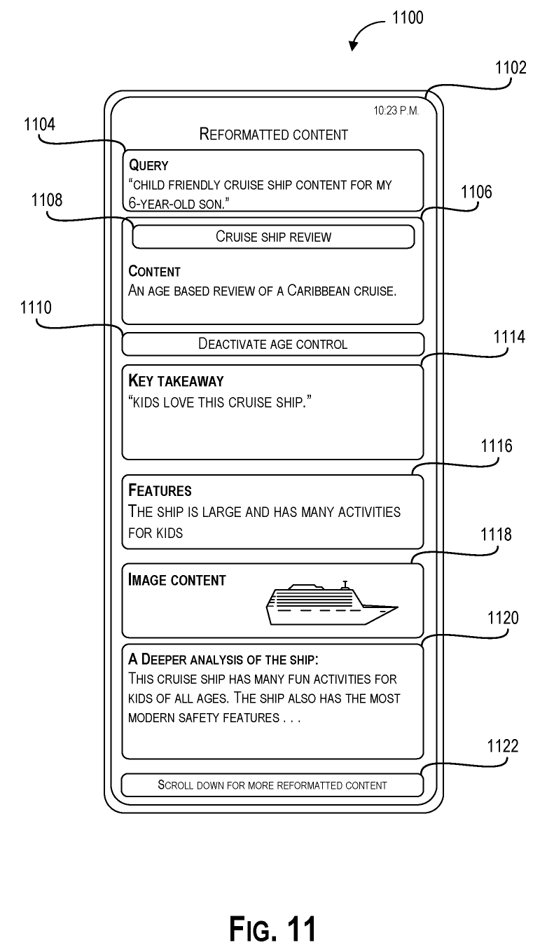

FIG. 11 depicts an example of generating age-based reformatted content according to example embodiments of the present disclosure. A computing device 1100 can include one or more features and/or capabilities of the computing device 50, the server computing system 60, the model development platform system 70, the computing device 300, and/or the computing device 400.

The computing device 1100 can include a display component 1102, query 1104, content 1106, reformatted title 1108, reformatted interface element 1110, reformatted key takeaway content 1114, reformatted text content 1116, reformatted image content 1118, reformatted deep dive content 1120, and interface element 1122.

The computing device 1100 can be configured to perform one or more operations comprising sending, obtaining, processing, and/or generating data comprising content data (e.g., content data associated with the content 1106), reformatted content data, query data (e.g., query data associated with the query 1104), and/or other data received by the computing device 1100. For example, the reformatted content data can be based on content data associated with the content 1106 and can comprise and/or be associated with the reformatted title 1108, the reformatted interface element 1110, the reformatted key takeaway content 1114, the reformatted text content 1116, the reformatted image content 1118, and/or the reformatted deep dive content 1120.

In this example, the computing device 1100 has been used to generate the query 1104 comprising “CHILD FRIENDLY CRUISE SHIP CONTENT FOR MY 6-YEAR-OLD SON.” In response to sending the query 1104 to a remote computing system that can provide content data and/or reformatted content data the computing system can receive data comprising content data associated with the content 1106 (e.g., content comprising “AN AGE BASED REVIEW OF A CARIBBEAN CRUISE”), which can comprise audio-video content associated with the query 1104. The content 1106 can be based on content data and can be associated with audio-video content. Further, the content 1106 can comprise a thumbnail image of the audio-video content associated with a review of the cruise ship.

In some embodiments, the computing device 1100 can use content data (e.g., content data associated with the content 1106) as an input to one or more machine-learned models (e.g., one or more machine-learned classification models and/or one or more class-based machine-learned models) that can be implemented on the computing device 1100 and/or that are implemented on a remote computing device that is able to send data to and/or receive data from the computing device 1100. The one or more machine-learned models can be configured and/or trained to detect, recognize, classify, and/or parse one or more features of the content data. For example, the one or more machine-learned models can recognize and/or classify one or more features of the content 1106 and generate reformatted content comprising an analysis of features of a cruise ship. Further, the one or more machine-learned models can be configured and/or trained to generate the reformatted title 1108 based on the content data. The reformatted title 1108 can comprise a reformatted title (“CRUISE SHIP REVIEW”) that is based on the content data associated with the content 1106.

The reformatted content can comprise the reformatted key takeaway content 1114 which indicates “KIDS LOVE THIS CRUISE SHIP.” The reformatted key takeaway 1114 can include a brief summary of the content and can include relevant information associated with the content. Further, the reformatted content can comprise the reformatted text content 1116 which indicates “FEATURES: THE SHIP IS LARGE AND HAS MANY ACTIVITIES FOR KIDS.” The reformatted text content 1116 can include structured data including lists of family friendly things to do on the cruise ship. Further, the reformatted image content 1118 can comprise an image (e.g., an image of the cruise ship) that is associated with the content. The reformatted image content 1118 can comprise an image from the source content (e.g., an image from the audio-video content of the cruise ship review), an image from non-source content (e.g., an image from the cruise ship’s website), and/or an image that was generated by one or more machine-learned models that are configured and/or trained to generate images (e.g., generative machine-learned models that are configured and/or trained to generate images of cruise ships based on the query 1104 or another input such as a prompt to generate an image of a particular cruise ship).

The reformatted content can comprise the reformatted deep dive content 1120 which indicates “A DEEPER ANALYSIS OF THE SHIP: THIS CRUISE SHIP HAS MANY FUN ACTIVITIES FOR KIDS OF ALL AGES. THE SHIP ALSO HAS THE MOST MODERN SAFETY FEATURES . . .” The reformatted deep dive content 1120 can include more comprehensive information associated with the content and can expand on the reformatted text content and provide a more detailed review of the cruise ship that is age based and does not include references to adult activities (e.g., night clubs) that may not be of interest to a child.

Further, the computing device can generate the reformatted interface element 1110 which comprises an interface element (“DEACTIVATE AGE CONTROL”) that can be displayed on the display component 1102 and used to activate or deactivate the age-based reformatted content generation. In some embodiments, the computing device 1100 can generate an age-based version of the reformatted content (e.g., a version of the reformatted content that is more suitable for children) and a version of the reformatted content in which there are no age-based modifications.

The reformatted interface element 1110 and/or the interface element 1122 can perform an action (e.g., activating or unlocking age control or scrolling the reformatted content) based on the computing device 1100 detecting an input to the reformatted interface element 1110 and/or the interface element 1122. Further, the interface element 1122 which indicates “SCROLL DOWN FOR MORE REFORMATTED CONTENT” can be used to show more of the reformatted content on the display component 1102.

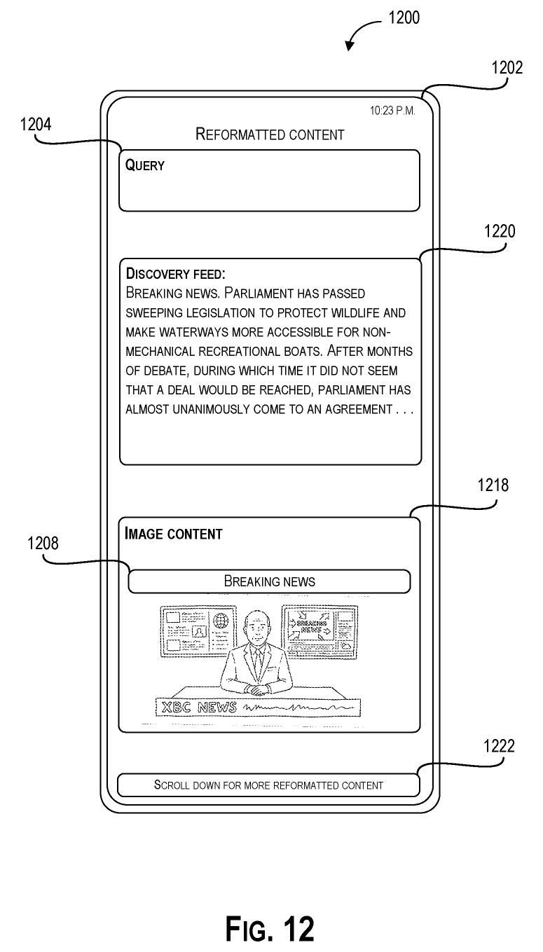

FIG. 12 depicts an example of generating discovery feed reformatted content according to example embodiments of the present disclosure. A computing device 1200 can include one or more features and/or capabilities of the computing device 50, the server computing system 60, the model development platform system 70, the computing device 300, and/or the computing device 400.

The computing device 1200 can include a display component 1202, query 1204, a reformatted title 1208, reformatted image content 1218, reformatted discovery feed content 1220, and an interface element 1222.

The computing device 1200 can be configured to perform one or more operations comprising sending, obtaining, processing, and/or generating data comprising content data (e.g., content data based on content associated with historical queries (e.g., historical search queries)), reformatted content data, query data (e.g., query data associated with historical queries), and/or other data received by the computing device 1200. The computing device 1200 can generate reformatted content data based on one or more portions of content data that are associated with one or more historical queries. For example, the reformatted content data can be based on content data that is selected based on the one or more historical queries. In some embodiments, one or more machine-learned models can determine the content data to use in generating the reformatted content data. For example, the one or more machine-learned models can receive one or more historical queries as an input and determine one or more portions of the content data that are associated with the one or more historical queries. For example, if a significant portion of the one or more historical queries are associated with a particular sports team (e.g., a professional basketball team) or a particular class of news media (e.g., political news or news about environmental legislation), content data associated with the one or more historical queries can be used as an input to generate reformatted content.

In this example, the computing device 1200 is configured to receive a query (e.g., a search query) but has not received a query and as a result, the query 1204 is empty. In the absence of a current query, the computing device 1200 can receive reformatted content that is automatically generated based on one or more historical queries that were previously sent from the computing device 1200 to a remote computing system that can provide content data and/or reformatted content data.

In some embodiments, the computing device 1200 can use content data (e.g., content data associated with one or more historical queries) as an input to one or more machine-learned models (e.g., one or more machine-learned classification models and/or one or more class-based machine-learned models) that can be implemented on the computing device 1200 and/or that are implemented on a remote computing device that is able to send data to and/or receive data from the computing device 1200. The one or more machine-learned models can be configured and/or trained to detect, recognize, classify, and/or parse one or more features of the content data. For example, the one or more machine-learned models can recognize and/or classify one or more features of the content data and generate reformatted content comprising an analysis of features of news articles and/or news video segments. Further, the one or more machine-learned models can be configured and/or trained to generate the reformatted title 1208 based on the content data. The reformatted title 1208 can comprise a reformatted title (“BREAKING NEWS”) that is based on the content data associated with the one or more historical queries.

The reformatted content can comprise an image (e.g., an image of the news anchor and news studio) that is associated with the content. The reformatted image content 1218 can comprise an image from the source content (e.g., an image from the audio-video content of the breaking news stream), an image from non-source content (e.g., an image from an article about the breaking news), and/or an image that was generated by one or more machine-learned models that are configured and/or trained to generate images (e.g., generative machine-learned models that are configured and/or trained to generate images of a news anchor delivering breaking news based on the one or more historical queries and/or another input such as a prompt to generate an image of a particular news anchor and news studio).

The reformatted content can comprise the reformatted discovery feed content 1220 which indicates “BREAKING NEWS. PARLIAMENT HAS PASSED SWEEPING LEGISLATION TO PROTECT WILDLIFE AND MAKE WATERWAYS MORE ACCESSIBLE FOR NON-MECHANICAL RECREATIONAL BOATS. AFTER MONTHS OF DEBATE, DURING WHICH TIME IT DID NOT SEEM THAT A DEAL WOULD BE REACHED, PARLIAMENT HAS ALMOST UNANIMOUSLY COME TO AN AGREEMENT . . .” The reformatted discovery feed content 1220 can include a summary of breaking news content from a plurality of content sources.

Further, the interface element 1222 can be used to perform an action (e.g., scrolling the reformatted discovery feed) based on the computing device 1200 detecting an input to the interface element 1222. Further, the interface element 1222 which indicates “SCROLL DOWN FOR MORE REFORMATTED CONTENT” can be used to show more of the reformatted discovery feed on the display component 1202.

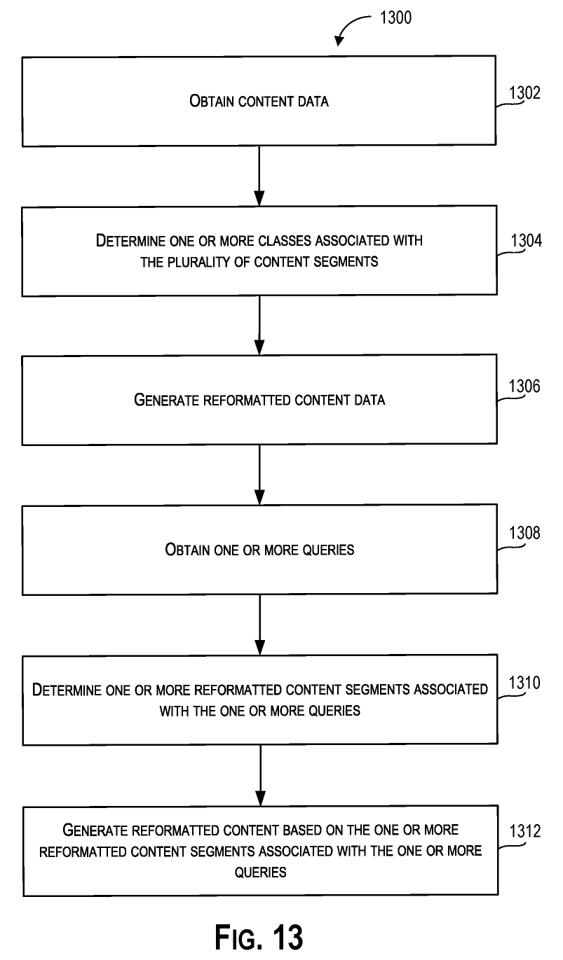

FIG. 13 depicts a flow chart diagram of an example method of generating reformatted content according to example embodiments of the present disclosure. One or more portions of the method 1300 can be executed and/or implemented on one or more computing devices or computing systems comprising, for example, the computing device 50, the server computing system 60, the model development platform system 70, and/or the computing device 300. Further, one or more portions of the method 1300 can be executed or implemented as an algorithm on the hardware devices or systems disclosed herein. FIG. 13 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1302, the method 1300 can include obtaining content data comprising a plurality of content segments associated with audio-video content. For example, the computing device 50 can receive content data comprising a large number of videos with sound that are sent from a streaming video service’s library of content. The content data can be received from a remote source (e.g., server computing system 60) via a network such as the network 49.

At 1304, the method 1300 can include determining, based on inputting the content data into one or more machine-learned classification models, one or more classes associated with the plurality of content segments. The one or more machine-learned classification models can be configured and/or trained to determine the one or more classes based on one or more features of the plurality of content segments. For example, the server computing system 60 can implement one or more machine-learned models that are configured and/or trained to determine the one or more classes based on input comprising the plurality of content segments associated with the content data.

At 1306, the method 1300 can include generating, based on inputting the plurality of content segments into one or more class-based machine-learned models, reformatted content data comprising a plurality of reformatted content segments associated with text content or image content that is based on the one or more features of the plurality of content segments. Each of the one or more class-based machine-learned models can be configured and/or trained to reformat the one or more features of the plurality of content segments associated with one class of the one or more classes, and wherein each content segment of the plurality of content segments is inputted into the class-based machine-learned model that is associated with the one or more classes of the content segment. For example, the server computing system 60 can implement one or more machine-learned models that are configured and/or trained to generate the reformatted content data based on input comprising the plurality of content segments associated with the content data.

At 1308, the method 1300 can include obtaining query data comprising one or more queries. For example, the one or more queries can comprise search queries. Further, the computing device 50 can receive data (e.g., query data) comprising one or more inputs from an input device (e.g., touchscreen or keyboard) of the computing device 50. The query data can be received from a local device and/or from a remote source (e.g., a remote computing system) via a network such as the network 49.

At 1310, the method 1300 can include determining one or more reformatted content segments that are associated with the one or more queries. For example, the server computing system 60 can access a search index and use the search index to determine one or more reformatted content segments that are associated with one or more queries.

At 1312, the method 1300 can include generating reformatted content based on the one or more reformatted content segments associated with the one or more queries. For example, the computing device 50 can generate one or more reformatted content data that can comprise text and image content based on audio-video content.

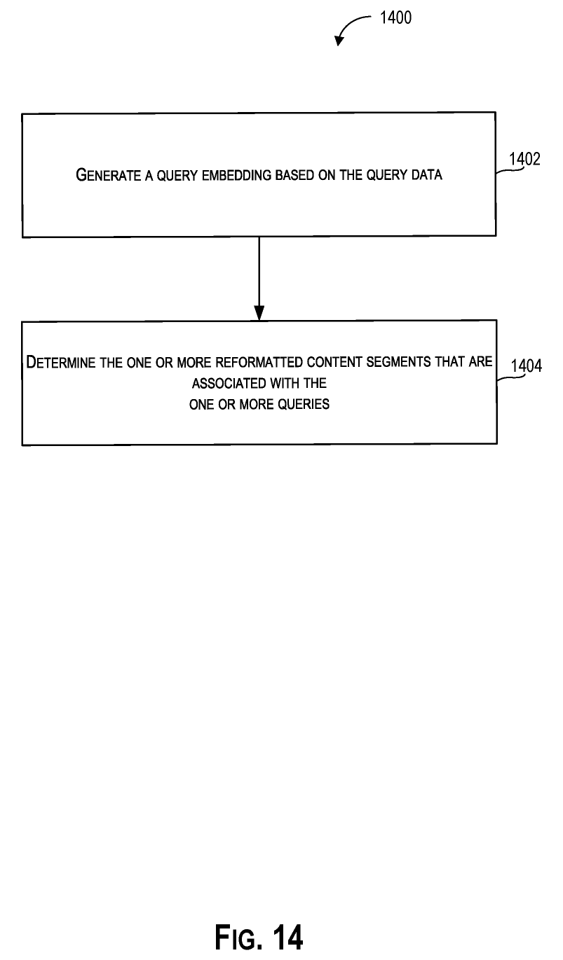

FIG. 14 depicts a flow chart diagram of an example method of determining reformatted content associated with queries according to example embodiments of the present disclosure. One or more portions of the method 1400 can be executed and/or implemented on one or more computing devices or computing systems comprising, for example, the computing device 50, the server computing system 60, the model development platform system 70, and/or the computing device 300. Further, one or more portions of the method 1400 can be executed or implemented as an algorithm on the hardware devices or systems disclosed herein. In some embodiments, one or more portions of the method 1400 can be performed as part of the method 1300 that is described with respect to FIG. 13. FIG. 14 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1402, the method 1400 can include generating a query embedding based on the query data. For example, the server computing system 60 can implement one or more machine-learned models that are configured and/or trained to generate a query embedding based on input comprising the query data.

At 1404, the method 1400 can include determining, based on comparing the query embedding to the plurality of reformatted content embeddings, the one or more reformatted content segments that are associated with the one or more queries. For example, the server computing system 60 can compare the query embedding to the plurality of reformatted content embeddings based on the plurality of reformatted content segments. In some embodiments, the one or more machine-learned models that generated the query embedding can be the same machine-learned models that generated a plurality of reformatted content embeddings that the query embedding is compared to.

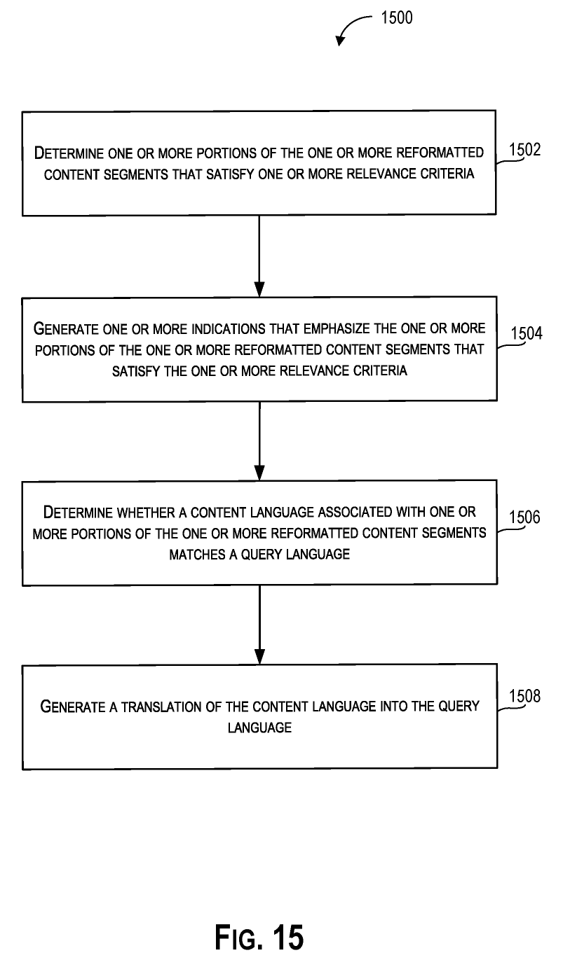

FIG. 15 depicts a flow chart diagram of an example method of generating reformatted content according to example embodiments of the present disclosure. One or more portions of the method 1500 can be executed and/or implemented on one or more computing devices or computing systems comprising, for example, the computing device 50, the server computing system 60, the model development platform system 70, and/or the computing device 400. Further, one or more portions of the method 1500 can be executed or implemented as an algorithm on the hardware devices or systems disclosed herein. In some embodiments, one or more portions of the method 1500 can be performed as part of the method 1300 that is described with respect to FIG. 13. FIG. 15 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 1502, the method 1500 can include determining one or more portions of the one or more reformatted content segments that satisfy one or more relevance criteria associated with a relevance of the one or more portions of the one or more reformatted content segments with respect to the one or more queries. For example, the server computing system 60 can implement one or more machine-learned models that are configured and/or trained to receive the one or more reformatted content segments and determine whether the one or more relevance criteria are satisfied. Further, the server computing system 60 can process text content associated with the one or more reformatted content segments and perform one or more text analysis techniques to determine whether the one or more relevance criteria are satisfied.

At 1504, the method 1500 can include generating one or more indications that emphasize the one or more portions of the one or more reformatted content segments that satisfy the one or more relevance criteria. Satisfying the one or more relevance criteria can comprise one or more key words associated with the one or more queries matching one or more key words in the one or more portions of the one or more reformatted content segments. Further, emphasizing the one or more portions of the one or more reformatted content segments that satisfy the one or more relevance criteria can comprise highlighting (e.g., green or yellow highlighting) the one or more portions, underlining the one or more portions, and/or increasing the font size of the one or more portions.

At 1506, the method 1500 can include determining whether a content language associated with one or more portions of the one or more reformatted content segments matches a query language associated with the one or more queries. For example, the computing device 50 can compare the query language used to generate the query to the language of the reformatted content segments.

At 1508, the method 1500 can include generating a translation of the content language into the query language in the one or more portions of the one or more reformatted content segments in which the content language does not match the query language. For example, the computing device 50 can generate a translation of the content language into the query language such that the query language is displayed instead of the content language or the query language is displayed adjacent to the content language (e.g., below the content language).

Further to the descriptions above, a user may be provided with controls allowing the user to make an election as to both if and/or when systems, programs, or features described herein may enable collection of user information (e.g., image information), and if the user is sent data or communications from a server. In addition, certain data may be treated in one or more ways before it is stored or used, so that certain information of a user may be removed. For example, a user’s identity may be treated so that certain other information associated with the user’s identity may not be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

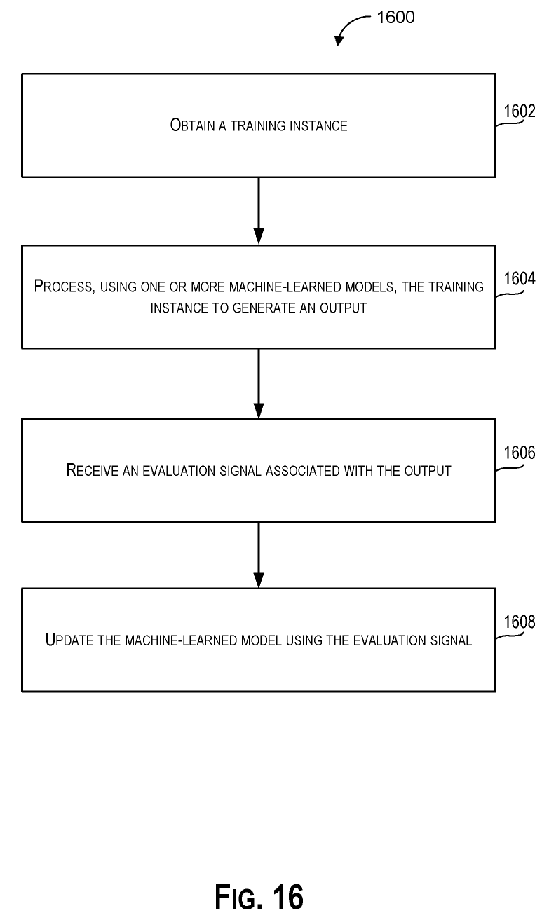

FIG. 16 depicts a flowchart of a method for training one or more machine-learned models according to aspects of the present disclosure. For example, an example machine-learned model can include a content processing model that is configured and/or trained to process data comprising content data and/or query data.

One or more portion(s) of example method 1600 can be implemented by a computing system that includes one or more computing devices such as, for example, computing systems described with reference to the other figures. Each respective portion of example method 1600 can be performed by any (or any combination) of one or more computing devices. Moreover, one or more portion(s) of example method 1600 can be implemented on the hardware components of the device(s) described herein, for example, to train one or more systems or models. FIG. 16 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 16 is described with reference to elements/terms described with respect to other systems and figures for exemplary illustrated purposes and is not meant to be limiting. One or more portions of example method 1600 can be performed additionally, or alternatively, by other systems.

At 1602, example method 1600 can include obtaining a training instance. A set of training data can include a plurality of training instances divided between multiple datasets (e.g., a training dataset, a validation dataset, or testing dataset). A training instance can be labeled or unlabeled. Although referred to in example method 1600 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 1604, example method 1600 can include processing, using one or more machine-learned models, the training instance to generate an output. The output can be directly obtained from the one or more machine-learned models or can be a downstream result of a chain of processing operations that includes an output of the one or more machine-learned models.

At 1606, example method 1600 can include obtaining an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-, or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1608, example method 1600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1600 can include implementing a number of generalization techniques (e.g., weight decays, dropouts, etc.) to improve the generalization capability of the models being trained.

In some implementations, example method 1600 can be implemented for training a machine-learned model from an initialized state to a fully trained state (e.g., when the model exhibits a desired performance profile, such as based on accuracy, precision, recall, etc.).

In some implementations, example method 1600 can be implemented for particular stages of a training procedure. For example, in some implementations, example method 1600 can be implemented for pre-training a machine-learned model. Pre-training can include, for example, large-scale training over potentially noisy data to achieve a broad base of performance levels across a variety of tasks/data types.

In some implementations, the example method 1600 can be implemented for fine-tuning a machine-learned model. Fine-tuning can include, for example, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 700 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 1600 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

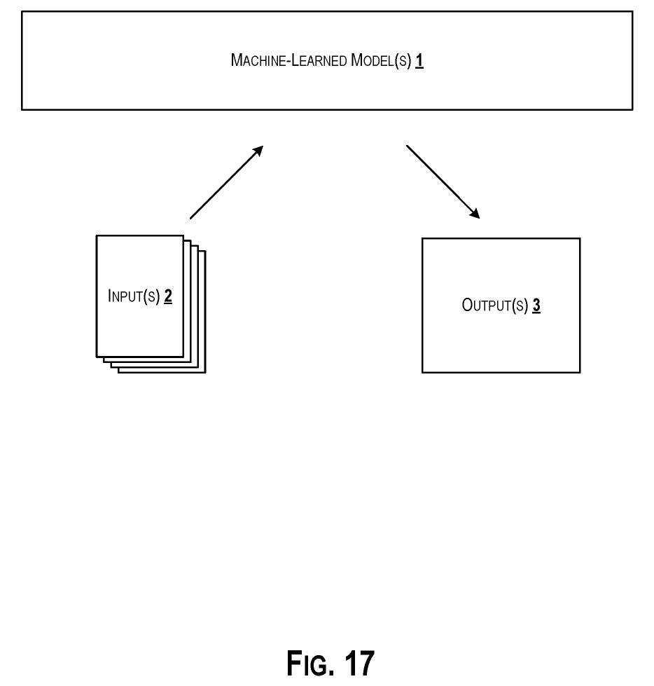

FIG. 17 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be, include, or otherwise be representative of any one or more of the machine-learned models described above with respect to the preceding figures. For example, machine-learned model(s) 1 can be or include, or otherwise be representative of any one or more of a classification machine-learned model and/or a class-based machine-learned model. Although various features, variations, and implementations described below are described with respect to machine-learned model(s) 1, it is to be understood that such features, variations, and implementations are to be understood as described with respect to each of a classification machine-learned model, a class-based machine-learned model, and/or any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for example, the diverse constituent models can work together to improve system-level fault tolerance by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for example, the group of activated weights can form an “expert” that is selected by the router. On each forward pass, only a subset of the total model weights may be engaged, thereby decreasing a quantity of operations performed for processing a given input compared to a densely activated model. In this manner, for example, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data, and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

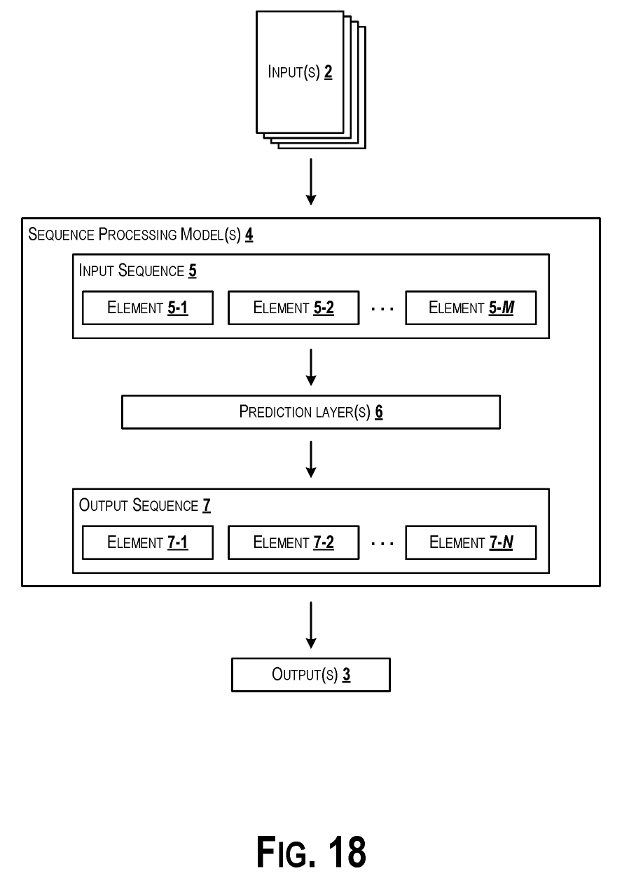

FIG. 18 is a block diagram of an example implementation of an example machine-learned model configured to process sequences of information. For example, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for example, models described in Gemma: Open Models Based on Gemini Research and Technology, Google; and/or Gemma 2: Improving Open Language Models at a Practical Size, Google.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google; PaliGemma 2: A Family of Versatile VLMs for Transfer, Google; Flamingo: a Visual Language Model for Few-Shot Learning, Google; and/or PaLI: A Jointly-Scaled Multilingual Language-Image Model, Google.

Sequence processing model(s) 4 can be multimodal. Example multimodal sequence processing models include, for example, models described in Gemini: A Family of Highly Capable Multimodal Models, Google; Gemini 1.5: Unlocking multimodal understanding across millions of tokens of context, Google.

Other example sequence processing models can operate to generate outputs or receive inputs in specific domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For example, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For example, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For example, a tokenizer can process a given portion of an input source and output a series of tokens (e.g., corresponding to input elements 5-1, 5-2, . . . , 5-M) that represent the portion of the input source. Various approaches to tokenization can be used. For example, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018). Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 18 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for example, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for example, assign a higher probability to the word “nails” than to the word “sawdust.”

A transformer is an example architecture that can be used in prediction layer(s) 6. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For example, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For example, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for example, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For example, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For example, an output “vocabulary” can include a set of classes into which an input sequence is to be classified. For example, a vision transformer block can pass latent state information to a multilayer perceptron that outputs a likely class value associated with an input image.

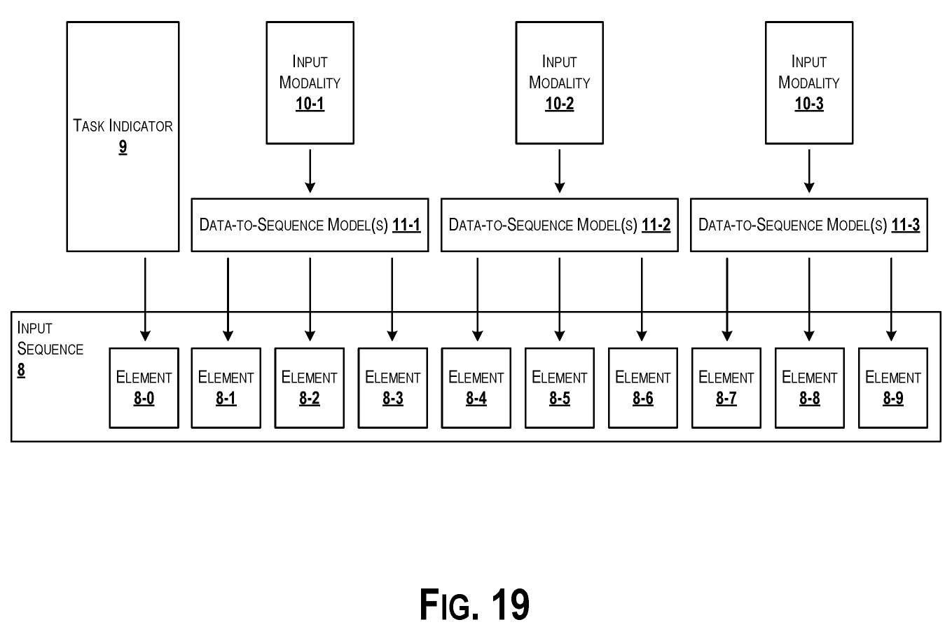

FIG. 19 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For example, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For example, an embedding space can have P dimensions. Input sequence 8 can be configured to contain a plurality of elements that have P dimensions. In this manner, for example, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For example, elements that correspond to discrete members of a predetermined vocabulary of tokens can map to discrete locations in the embedding space that are associated with those tokens. Other elements can be continuously distributed across the embedding space. For example, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for example, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for example, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For example, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For example, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

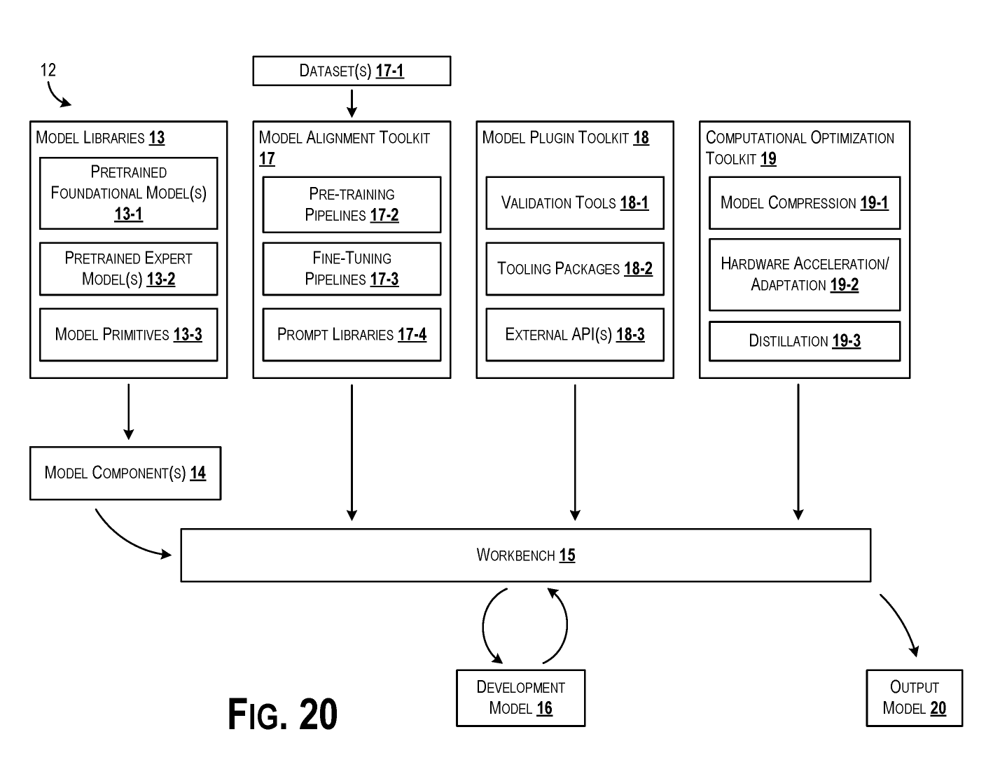

FIG. 20 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral features. Alignment can include increasing the accuracy, precision, recall, etc. of model outputs. Alignment can include enforcing output styles, schema, or other preferential features of model outputs. Alignment can be general or domain-specific. For example, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For example, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for example, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For example, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example method 1600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For example, a machine-learned model can use tools to increase performance quality where appropriate. For example, deterministic tasks can be offloaded to dedicated tools in lieu of probabilistically performing the task with an increased risk of error. For example, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models (e.g., understanding an intent in an unstructured request for a task) while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for example, fine-tuning training data for training a model to use a tool.

Model plugin toolkit 18 can include interfaces for calling external application programming interfaces (APIs) 18-3. For example, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For example, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For example, tools for model compression 19-1 can allow development model 16 to be reduced in size while maintaining a desired level of performance. For example, model compression 19-1 can include quantization workflows, weight pruning and sparsification techniques, etc. Tools for hardware acceleration 19-2 can facilitate the configuration of the model storage and execution formats to operate optimally on different hardware resources. For example, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For example, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for example, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

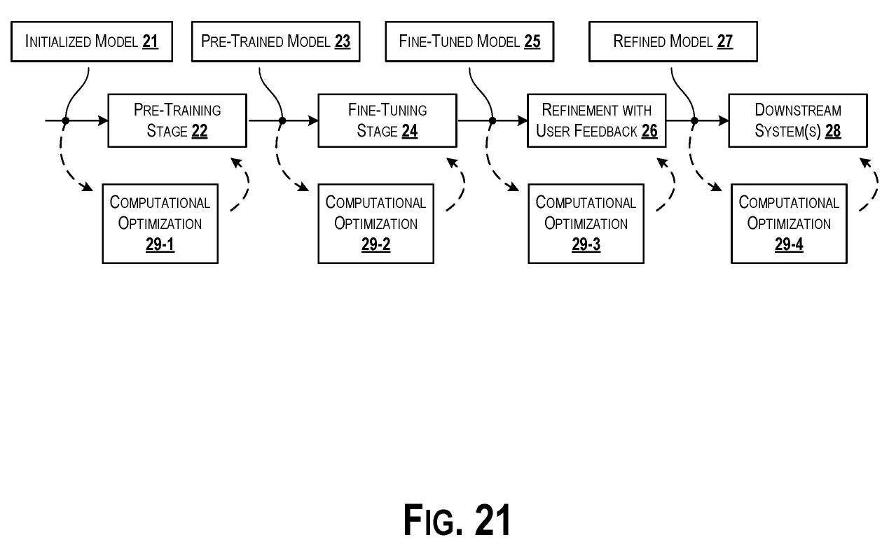

FIG. 21 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 21 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 21 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For example, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For example, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

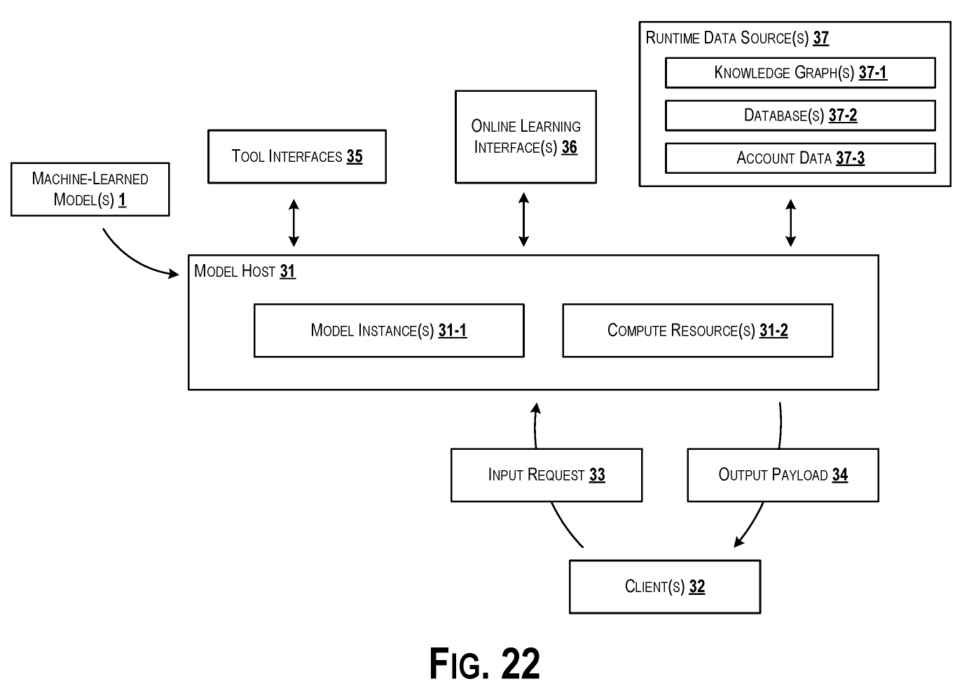

FIG. 22 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For example, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For example, online learning interface(s) 36 can be used within reinforcement learning loops to retrieve user feedback on inferences served by model host 31. Model host 31 can access runtime data source(s) 37 for augmenting input(s) 2 with additional contextual information. For example, runtime data source(s) 37 can include a knowledge graph 37-1 that facilitates structured information retrieval for information associated with input request(s) 33 (e.g., a search engine service). Runtime data source(s) 37 can include public or private, external, or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 32 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For example, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For example, an inference session with a particular model may generate significant amounts of computational results that can be re-used for future inference runs (e.g., using a key-value (KV) cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) b can be obtained directly from input request 33 or can be retrieved using input request 33. Input request 33 can be submitted to model host 31 via an API.

Model host 31 can perform inference over batches of input requests 33 in parallel. For example, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for example, model host 31 can perform inference on the batch in parallel, such that output(s) 3 can also contain the batch dimension and return the inference results for the batched input(s) 2 in parallel. In this manner, for example, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For example, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) b can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For example, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For example, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For example, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For example, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For example, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For example, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For example, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For example, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for example, synthetic data for training other machine-learned models. The context can include arbitrary data type(s). Machine-learned model(s) 1 can be configured to generate output(s) 3 that represent data that aligns with the desired data. For example, machine-learned model(s) 1 can be configured to generate data values for populating a dataset. Values for the data object(s) can be selected based on the context (e.g., based on a probability determined based on the context).

FIG. 23 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., Transmission Control Protocol/Internet Protocol (TCP/IP), Hypertext Transfer Protocol (HTTP), Simple Mail Transfer Protocol (SMTP), File Transfer Protocol (FTP)), encodings or formats (e.g., Hyper Text Markup Language (HTML), Extensible Markup Language (XML)), or protection schemes (e.g., Virtual Private Network (VPN), secure HTTP, Secure Sockets Layer (SSL)). Network 49 can also be implemented via a system bus. For example, one or more devices or systems of FIG. 23 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, one or more light detection and ranging (LIDAR) devices, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For example, server computing system(s) 60 can implement model host 31 on behalf of client(s) 32 on computing device 50. For example, machine-learned models 65 can be implemented by server computing system 60 as a portion of a web service (e.g., remote machine-learned model hosting service, such as an online interface for performing machine-learned model operations over a network on server computing system(s) 60). For example, server computing system(s) 60 can communicate with computing device 50 over a local intranet or internet connection. For example, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and/or combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 23 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for example, computing system 50 or server computing system(s) 60 can develop, update/train, or refine machine-learned models based on local datasets (e.g., for model personalization/customization, as permitted by user data preference selections).

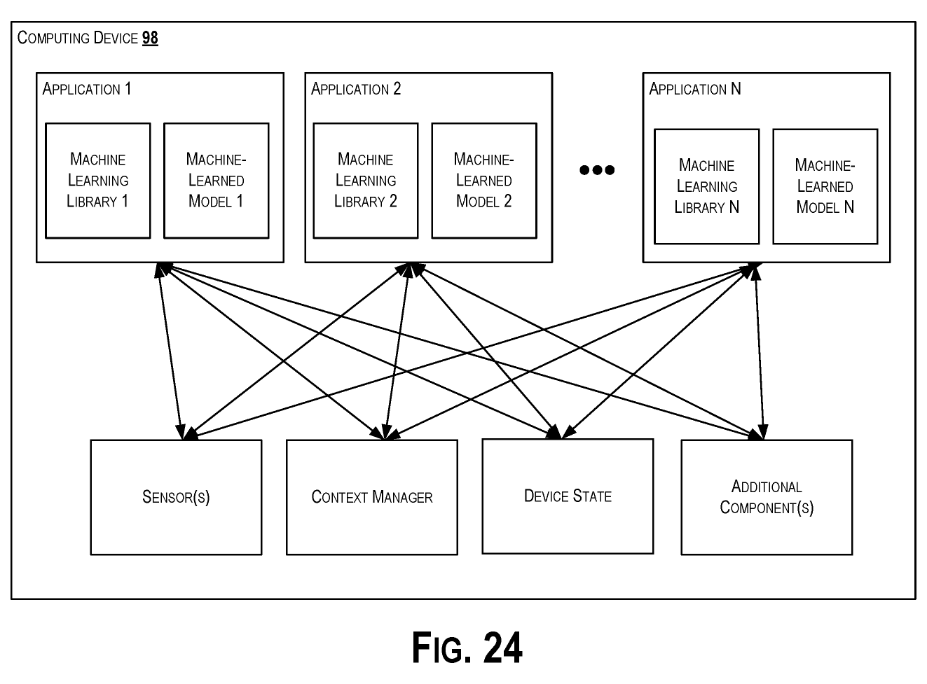

FIG. 24 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For example, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 24, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

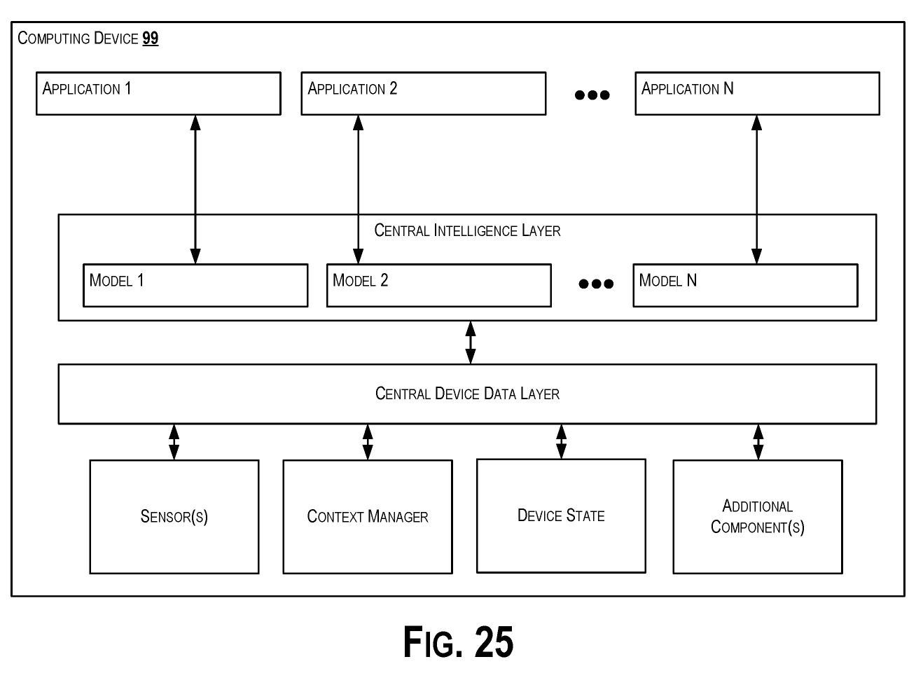

FIG. 25 is a block diagram of an example computing device 99 that performs according to example embodiments of the present disclosure. The computing device 99 can be the same as or different from computing device 98. Computing device 99 can be a user computing device or a server computing device (e.g., computing device 50, server computing system(s) 60, etc.). Computing device 98 can implement model host 31. For example, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 25, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 25, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For example, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For example, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method of generating reformatted content, the computer-implemented method comprising:
obtaining, by a computing system comprising one or more processors, content data comprising a plurality of content segments associated with audio-video content;
determining, by the computing system, based on inputting the content data into one or more machine-learned classification models, one or more classes associated with the plurality of content segments, wherein the one or more machine-learned classification models are configured to determine the one or more classes based on one or more features of the plurality of content segments;
generating, by the computing system, based on inputting the plurality of content segments into one or more class-based machine-learned models, reformatted content data comprising a plurality of reformatted content segments associated with text content or image content that is based on the one or more features of the plurality of content segments, wherein each of the one or more class-based machine-learned models is configured to reformat the one or more features of the plurality of content segments associated with one class of the one or more classes, and wherein each content segment of the plurality of content segments is inputted into the class-based machine-learned model that is associated with the one or more classes of the content segment;
obtaining, by the computing system, query data comprising one or more queries;
determining, by the computing system, one or more reformatted content segments that are associated with the one or more queries; and
generating, by the computing system, reformatted content based on the one or more reformatted content segments associated with the one or more queries.

2. The computer-implemented method of claim 1, wherein the one or more class-based machine-learned models comprise a class-based machine-learned model that is configured to generate the reformatted content data based on one or more content segments of the plurality of content segments that are unclassified or one or more content segments of the plurality of content segments that are classified as being in a generic class.

3. The computer-implemented method of claim 1, wherein the plurality of reformatted content segments comprise content information associated with indexing or retrieving the plurality of content segments, and wherein the content information comprises one or more indications of the one or more classes associated with the plurality of content segments, one or more identifiers of the plurality of content segments, or one or more web resources associated with the plurality of content segments.

4. The computer-implemented method of claim 1, wherein the one or more class-based machine-learned models are configured to modify, based on the one or more classes associated with the plurality of content segments, a spatial arrangement of the text content or image content associated with the plurality of reformatted content segments, and wherein the one or more class-based machine-learned models are configured to modify, based on the one or more classes associated with the plurality of content segments, a color scheme or typography associated with the plurality of reformatted content segments.

5. The computer-implemented method of claim 1, wherein the one or more class-based machine-learned models are configured to determine, based on performing one or more natural language processing operations on the plurality of content segments, one or more portions of the plurality of content segments that are associated with one or more features of a product or service, and wherein the one or more class-based machine-learned models are configured to generate the plurality of reformatted content segments based on the one or more features of the product or service.

6. The computer-implemented method of claim 1, wherein the one or more class-based machine-learned models are configured to determine, based on performing one or more natural language processing operations on the plurality of content segments, one or more portions of the plurality of content segments that are associated with one or more advantages or disadvantages of an object, a place, or an event, and wherein the one or more class-based machine-learned models are further configured to generate the plurality of reformatted content segments based on the one or more advantages or disadvantages of the object, the place, or the event.

7. The computer-implemented method of claim 1, wherein the one or more class-based machine-learned models are configured to determine, based on performing one or more natural language processing operations on the plurality of content segments, one or more portions of the plurality of content segments that are associated with rankings of products, rankings of services, or rankings of places, and wherein the one or more class-based machine-learned models are configured to generate the plurality of reformatted content segments based on the rankings of products, the rankings of services, or the rankings of places.

8. The computer-implemented method of claim 1, wherein the one or more class-based machine-learned models are configured to determine, based on performing one or more natural language processing operations on the plurality of content segments, one or more portions of the plurality of content segments that are associated with one or more instructions, wherein the one or more class-based machine-learned models are configured to generate the plurality of reformatted content segments based on the one or more portions of the plurality of content segments that are associated with the one or more instructions, and wherein the one or more instructions comprise one or more assembly instructions, one or more instructions to perform a task, or one or more recipes.

9. The computer-implemented method of claim 1, wherein the one or more class-based machine-learned models are configured to determine, based on performing one or more natural language processing operations on the plurality of content segments, one or more portions of the plurality of content segments that are associated with dialogue, wherein the one or more class-based machine-learned models are configured to recognize different speakers associated with the dialogue, and wherein the one or more class-based machine-learned models are further configured to generate the plurality of reformatted content segments based on the dialogue and recognition of the different speakers associated with the dialogue.

10. The computer-implemented method of claim 1, wherein the one or more class-based machine-learned models are configured to determine a plurality of titles or a plurality of summaries associated with the plurality of content segments, and wherein the one or more class-based machine-learned models are configured to generate the plurality of reformatted content segments based on the plurality of titles or the plurality of summaries.

11. The computer-implemented method of claim 1, wherein the one or more class-based machine-learned models are configured to generate a plurality of reformatted content segments comprising one or more interactive elements associated with the plurality of content segments, and wherein the one or more interactive elements comprise one or more interactive links to one or more web resources associated with the plurality of content segments.

12. The computer-implemented method of claim 1, wherein the one or more machine-learned classification models are configured to recognize a spoken language, a written language, or one or more objects in the audio-video content, and wherein the one or more classes are based on recognition of the one or more objects, the spoken language, or the written language in the audio-video content.

13. The computer-implemented method of claim 1, wherein the one or more class-based machine-learned models are configured to determine one or more transformations of the one or more features of the plurality of content segments, and wherein the one or more class-based machine-learned models are configured to generate the plurality of reformatted content segments based on the transformations of the one or more features of the plurality of content segments.

14. The computer-implemented method of claim 1, wherein the one or more class-based machine-learned models comprise one or more multimodal transformer models that are trained to generate the reformatted content data based on training data comprising training content data and corresponding ground-truth reformatted training content data, wherein the training data further comprises a plurality of training queries, and wherein the training content data comprises a plurality of training audio-video segments, a plurality of training video segments, a plurality of training images, a plurality of training text segments, or a plurality of training audio segments.

15. The computer-implemented method of claim 1, wherein the content data further comprises a plurality of content segments associated with text content, and wherein the reformatted content data further comprises a plurality of reformatted content segments associated with audio content, a plurality of reformatted content segments associated with audio-video content, or a plurality of reformatted content segments associated with audio-video content.

16. The computer-implemented method of claim 1, wherein the plurality of reformatted content segments comprise a corresponding plurality of reformatted content embeddings, and wherein the determining, by the computing system, one or more reformatted content segments that are associated with the one or more queries comprises:
generating, by the computing system, a query embedding based on the query data; and
determining, by the computing system, based on comparing the query embedding to the plurality of reformatted content embeddings, the one or more reformatted content segments that are associated with the one or more queries.

17. The computer-implemented method of claim 1, wherein the generating, by the computing system, reformatted content based on the one or more reformatted content segments that are associated with the one or more queries comprises:
determining, by the computing system, one or more portions of the one or more reformatted content segments that satisfy one or more relevance criteria associated with a relevance of the one or more portions of the one or more reformatted content segments with respect to the one or more queries; and
generating, by the computing system, one or more indications that emphasize the one or more portions of the one or more reformatted content segments that satisfy the one or more relevance criteria.

18. The computer-implemented method of claim 1, wherein the generating, by the computing system, reformatted content based on the one or more reformatted content segments that are associated with the one or more queries comprises:
determining, by the computing system, whether a content language associated with one or more portions of the one or more reformatted content segments matches a query language associated with the one or more queries; and
generating, by the computing system, a translation of the content language into the query language in the one or more portions of the one or more reformatted content segments in which the content language does not match the query language.

19. One or more tangible non-transitory computer-readable media storing computer-readable instructions that when executed by one or more processors cause the one or more processors to perform operations, the operations comprising:
obtaining content data comprising a plurality of content segments associated with audio-video content;
determining, based on inputting the content data into one or more machine-learned classification models, one or more classes associated with the plurality of content segments, wherein the one or more machine-learned classification models are configured to determine the one or more classes based on one or more features of the plurality of content segments;
generating, based on inputting the plurality of content segments into one or more class-based machine-learned models, reformatted content data comprising a plurality of reformatted content segments associated with text content or image content that is based on the one or more features of the plurality of content segments, wherein each of the one or more class-based machine-learned models is configured to reformat the one or more features of the plurality of content segments associated with one class of the one or more classes, and wherein each content segment of the plurality of content segments is inputted into the class-based machine-learned model that is associated with the one or more classes of the content segment;
obtaining query data comprising one or more queries;
determining one or more reformatted content segments that are associated with the one or more queries; and
generating reformatted content based on the one or more reformatted content segments that are associated with the one or more queries.

20. A computing system comprising:
one or more processors;
one or more non-transitory computer-readable media storing instructions that when executed by the one or more processors cause the one or more processors to perform operations comprising:
obtaining content data comprising a plurality of content segments associated with audio-video content;
determining, based on inputting the content data into one or more machine-learned classification models, one or more classes associated with the plurality of content segments, wherein the one or more machine-learned classification models are configured to determine the one or more classes based on one or more features of the plurality of content segments;
generating, based on inputting the plurality of content segments into one or more class-based machine-learned models, reformatted content data comprising a plurality of reformatted content segments associated with text content or image content that is based on the one or more features of the plurality of content segments, wherein each of the one or more class-based machine-learned models is configured to reformat the one or more features of the plurality of content segments associated with one class of the one or more classes, and wherein each content segment of the plurality of content segments is inputted into the class-based machine-learned model that is associated with the one or more classes of the content segment;
obtaining query data comprising one or more queries;
determining one or more reformatted content segments that are associated with the one or more queries; and
generating reformatted content based on the one or more reformatted content segments that are associated with the one or more queries.
